(19) United States
(12) Patent Application Publication
(10) Pub. No.: US 2026/0040407 A1
(43) Pub. Date: Feb. 5, 2026

(54) SYSTEMS AND DEVICES FOR HIGH-TEMPERATURE THERMAL ENERGY STORAGE AND METHODS FOR USE

(71) Applicant: Calectra, Inc., Oakland, CA (US)

(72) Inventors: Nathaniel Jacob Weger, Oakland, CA (US); Pauliina Hilma Annikki Meskanen, Oakland, CA (US); Fox Hunter Thorpe, Davis, CA (US)

(21) Appl. No.: 19/287,720

(22) Filed: Jul. 31, 2025

Related U.S. Application Data
(63) Continuation of application No. PCT/US2025/026779, filed on Apr. 29, 2025.
(60) Provisional application No. 63/639,721, filed on Apr. 29, 2024.

(51) Int. Cl. H05B 3/00; F28D 20/00

(52) U.S. Cl. CPC H05B 3/0004; F28D 20/0056; F28D 2020/0021; F28D 2020/0078; H05B 2203/013; H05B 2203/035

(57) ABSTRACT

Thermal storage units may comprise a substrate and one or more optional coatings configured to, for example, protect the substrate from, for example, corrosive environments, increase the thermal and/or chemical stability of the substrate and/or coating layers. The substrates may comprise silicon carbide and/or a composite material and may be configured to be resistively heated to temperatures within a range of 1000-2000° C. Heated thermal storage units may be exposed to a flow of heat transfer fluid that may absorb heat from the thermal storage units and, once heated, the flow of heat transfer fluid may be directed to industrial process equipment to provide heat thereto.

### RELATED APPLICATION

This application is a CONTINUATION of International Application Number PCT/US2025/026779, filed 29 Apr. 2025 and entitled “SYSTEMS AND DEVICES FOR HIGH-TEMPERATURE THERMAL ENERGY STORAGE AND METHODS FOR USE”, which is an INTERNATIONAL (PCT) patent application claiming priority to United States Provisional Patent Application Number: 63/639,721, filed on 29 Apr. 2024 and entitled “AIR-STABLE, RESISTIVELY HEATED SiC-CONTAINING MATERIALS FOR HIGH-TEMPERATURE THERMAL ENERGY STORAGE, which is incorporated by reference herein in its entirety.

### FIELD OF THE INVENTION

The present disclosure relates to thermal energy storage systems. More particularly, the present disclosure relates to high-temperature energy storage systems that store electrical energy in the form of thermal energy by converting electricity into high-temperature heat via direct resistive heating for various applications including the supply of heat to industrial processes. The high-temperature energy storage systems and/or components thereof may be configured for stability in one or more atmospheres including inert or reactive atmospheres and/or atmospheres that include, for example, flue gases, CO2, CO, CH4, H20, steam, hydrogen, argon, air, and combinations thereof.

### BACKGROUND

Industrial process heat, i.e. heat up to 1600° C., is necessary for producing essential materials such as cement, steel, and glass, and accounts for one-quarter of global energy consumption. Since 90% of industrial process heat is traditionally produced from fossil fuels such as natural gas, coal, and oil, industrial process heat is responsible for 10% of global and 9% of U.S. carbon dioxide emissions.

High-temperature thermal storage systems are capable of storing energy generated from intermittent renewable sources like solar and wind. Thermal storage systems capture and store energy in the form of heat during one time period, store the heat in a storage device, and release the heat for an intended use during another time period (e.g., on demand). Some thermal energy storage systems may absorb energy in one form, such as incoming solar or electric power, and deliver output energy in a different form, such as heat that is carried by a liquid or gas. However, the range of temperatures across which the storage medium or bulk storage material can be heated and cooled is an important determinant of the amount of energy that can be stored per unit of material. In some thermal storage systems, the storage medium or bulk storage material may be substrates formed of electrically conductive refractory materials.

There is a need for high-temperature thermal storage systems that deliver greater than 1000° C. process heat in an industrial setting. Such solutions are limited due to short material lifetime or high heat transfer cost.

### SUMMARY

Disclosed herein are thermal storage units and thermal storage systems for storing high-temperature heat and/or converting heat to electricity, heated heat transfer fluid, and/or steam. The thermal storage units comprise a substrate comprising silicon carbide and/or a composite material such as silicon carbide and at least one of an oxide, a carbide, a boride, a nitride, a phosphate, a silicate, a silicide, and a zirconate. Additionally, or alternatively, the thermal storage units disclosed herein may comprise silicon carbide composite material(s) like SiC—C, SiC—B4C, SiC—Cr2O3, SiC—Al2O3, SiC—CeC2,SiC—CaO, and SiC—MgO.

The thermal storage units disclosed herein may be configured to be compatible with, for example, a corrosive, inert, and/or oxygenated atmosphere that may include, for example, air, argon gas, nitrogen, H2O, steam, CO2, CO, CH4, hydrogen and/or combinations thereof.

The thermal storage unit(s) may be any form factor including, but not limited to a cube, a rectangular cuboid, a truncated cylinder, a disk, a hexagon, a tube, and a rod and they may be configured to be resistively heated via electricity to temperatures within a range of about 1000° C. to about 2000° C. and may be configured to store heat ranging from about 1000° C. to about 2000° C. The thermal storage units disclosed herein may be configured to be reused (e.g., heated and discharged) many times (e.g., 10-10,000) over their lifespan.

In some embodiments, the thermal storage units disclosed herein may configured to be arranged in a stack and/or tessellation of thermal storage units and two or more of the thermal storage units of the stack/tessellation may be in electrical and/or physical communication with one another.

In some embodiments, thermal storage units disclosed herein comprising one or more coating layer(s) configured to, for example, protect the thermal storage units, increase their thermal and/or chemical stability, and/or enhance the ability of a coating layer to adhere to a surface of a substrate and/or another coating layer. For example, a coating layer may be configured to protect a substrate from a heat transfer fluid and/or a corrosive, or oxidizing, environment. Coating layers may be configured as, for example, a bonding coating layer configured to assist with adherence of another coating layer of the plurality of coating layers to the thermal storage unit, a protective coating layer configured to protect the thermal storage unit, and/or a surface coating layer configured to, for example, prevent and/or control gas phase reactions between the thermal storage unit and an atmosphere in which the thermal storage unit is resident. In some embodiments, one or more coating layers may be intermediate coating layer(s) configured to minimize thermal and/or chemical mismatch between the substrate and one or more of the coating layer(s) of the thermal storage unit. For example, in some embodiments, a thermal storage unit may include three coating layers, wherein a first coating layer may be in contact with a surface of the thermal storage unit and is configured as a base coating layer, a second layer may be positioned between the first and third coating layers and is configured to provide thermal expansion stability and/or chemical stability between materials comprising the substrate, first, second, and/or third coating layers, and a third layer may be configured to protect the thermal storage unit.

In some embodiments, the thermal storage units may be configured to be reheated after cooling via exposure to a heat transfer fluid.

The thermal storage systems disclosed herein may include one or more stacks and/or an array of stacks of thermal storage units arranged to be in electrical communication with one another, a coupling configured and arranged to couple the stack and/or thermal storage units in the stack to an electricity source (e.g., a renewable and/or non-renewable electricity source) configured to supply electricity to the plurality of thermal storage units, a coupling to an electrical ground, and a housing configured to house the stack. The electricity supplied to the plurality of thermal storage units may resistively heat the plurality of thermal storage units.

The systems disclosed herein may include a heat transfer fluid circulation system configured to circulate a volume heat transfer fluid within and/or through the housing so that heat is transferred from the stack to the volume of heat transfer fluid, thereby generating a volume of heated heat transfer fluid, wherein the heat transfer fluid circulation system is further configured to deliver the heated heat transfer fluid to an industrial process outlet. The industrial process outlet may be in communication with the housing and configured to communicate a portion of the volume of heated heat transfer fluid from the housing to industrial process equipment proximate to the industrial process outlet.

Exemplary industrial processing equipment includes, but is not limited to, a furnace, a blast furnace, cement processing equipment, metal processing equipment, nickel processing equipment, copper processing equipment, rare earth metal processing equipment, aluminum processing equipment, ceramic processing equipment, steel processing equipment, glass processing equipment, steam engines, and chemical processing equipment.

The heat transfer fluid may be, for example, water, gases, CO2, nitrogen, CO, CH4, H2O, steam, hydrogen, argon, air, and/or combinations thereof. In some embodiments, the heat transfer circulation system may be configured to remove heat transfer fluid from the industrial process equipment and recirculate it through the housing so that it may be reheated and redelivered to the industrial process equipment.

In some embodiments, the systems disclosed herein may include an array of stacks of the same type of thermal storage unit. Alternatively, the systems disclosed herein may include a first set of a first type of stacks and second set of a second type of stacks. In these embodiments, the first and second sets may be separated from one another with, for example, a wall and/or empty space. Additionally, or alternatively, the first and second sets of stacks may be exposed to two different heat transfer fluids that may be circulated by one heat transfer fluid system or two different heat transfer fluid circulation systems. When two heat transfer fluid circulation systems are used a first heat transfer fluid circulation system may be configured to circulate a volume of a first heat transfer fluid within and/or through the housing so that heat is transferred from the first stack to the volume of first heat transfer fluid, thereby generating a volume of heated first heat transfer fluid and a second heat transfer fluid circulation system may be configured to circulate a volume of a second heat transfer fluid within and/or through the housing so that heat is transferred from the second stack to the volume of second heat transfer fluid, thereby generating a volume of heated second heat transfer fluid. The first heat transfer fluid circulation system may also be configured to deliver the heated second heat transfer fluid to one or more industrial process outlet(s) and the second heat transfer fluid circulation system may also be configured to deliver the heated second heat transfer fluid to one or more industrial process outlet(s).

### BRIEF DESCRIPTION OF THE DRAWINGS

The present invention is illustrated by way of example, and not limitation, in the figures of the accompanying drawings.

FIG. 1A provides a schematic diagram of a side view of an exemplary first block-shaped thermal storage unit, in accordance with some embodiments of the present invention;

FIG. 1B provides a schematic diagram of a side view of an exemplary second block-shaped thermal storage unit, in accordance with some embodiments of the present invention;

FIG. 1C provides a schematic diagram of a side view of an exemplary third block-shaped thermal storage unit, in accordance with some embodiments of the present invention;

FIG. 1D provides a schematic diagram of a side view of fourth block-shaped thermal storage unit, in accordance with some embodiments of the present invention;

FIG. 2A provides a schematic diagram of a top-perspective view of a first cylindrically-shaped thermal storage unit comprising a cylindrical substrate, in accordance with some embodiments of the present invention;

FIG. 2B provides a schematic diagram of a top view of a second cylindrically-shaped thermal storage unit, in accordance with some embodiments of the present invention;

FIG. 2C provides a schematic diagram of a top view of a third cylindrically-shaped thermal storage unit, in accordance with some embodiments of the present invention;

FIG. 2D provides a schematic diagram of a top view of a fourth cylindrically-shaped thermal storage unit, in accordance with some embodiments of the present invention;

FIG. 3A provides a schematic diagram of a top-perspective view of a first hexagonally-shaped thermal storage unit, in accordance with some embodiments of the present invention;

FIG. 3B provides a schematic diagram of a top view of a second hexagonally-shaped thermal storage unit, in accordance with some embodiments of the present invention;

FIG. 3C provides a schematic diagram of a top view of a third hexagonally-shaped thermal storage unit, in accordance with some embodiments of the present invention;

FIG. 3D provides a schematic diagram of a top view of a fourth hexagonally-shaped thermal storage unit, in accordance with some embodiments of the present invention;

FIG. 4A provides a schematic diagram of a side view of another hexagonally-shaped thermal storage unit, in accordance with some embodiments of the present invention;

FIG. 4B provides a schematic diagram of a side view of an exemplary second hexagonally-shaped thermal storage unit with top and bottom coating layers, in accordance with some embodiments of the present invention;

FIG. 4C provides a schematic diagram of a side view of an exemplary third hexagonally-shaped thermal storage unit with top and bottom coating layers, in accordance with some embodiments of the present invention;

FIG. 4D provides a schematic diagram of a side view of fourth hexagonally-shaped thermal storage unit with top and bottom coating layers, in accordance with some embodiments of the present invention;

FIG. 5A provides a schematic diagram of a top-perspective view of a first tube-shaped thermal storage unit, in accordance with some embodiments of the present invention;

FIG. 5B provides a schematic diagram of a top view of a second tube-shaped thermal storage unit, in accordance with some embodiments of the present invention;

FIG. 5C provides a schematic diagram of a top view of a third tube-shaped thermal storage unit, in accordance with some embodiments of the present invention;

FIG. 5D provides a schematic diagram of a top view of a fourth tube-shaped thermal storage units, in accordance with some embodiments of the present invention;

FIG. 6A provides a schematic diagram of a top view of a thermal storage unit with a plurality of channels therein, in accordance with some embodiments of the present invention;

FIG. 6B provides a schematic diagram of a detailed view of a portion of the thermal storage unit of FIG. 6A showing a channel with four coating layers, in accordance with some embodiments of the present invention;

FIG. 6C provides a schematic diagram of a detailed view of a portion of the thermal storage unit of FIG. 6A showing a channel with one multi-purpose coating layers, in accordance with some embodiments of the present invention;

FIG. 6D provides a schematic diagram of a detailed view of a portion of the thermal storage unit of FIG. 6A showing a channel with two coating layers, in accordance with some embodiments of the present invention;

FIG. 7A provides a schematic diagram of a side view of a stack that includes a plurality block-shaped thermal storage units, in accordance with some embodiments of the present invention;

FIG. 7B provides a schematic diagram of a side view of a stack that includes a plurality cylindrically-shaped thermal storage units, in accordance with some embodiments of the present invention;

FIG. 7C provides a schematic diagram of a side view of a stack that includes a plurality of hexagonally-shaped thermal storage units, in accordance with some embodiments of the present invention;

FIG. 7D provides a schematic diagram of a side view of a stack that includes a plurality of tube-shaped thermal storage units, in accordance with some embodiments of the present invention;

FIG. 7E provides a schematic diagram of a top view of a tessellation, or hexagonal grid, of thermal storage units, in accordance with some embodiments of the present invention;

FIG. 8 is a flowchart illustrating a process for fabricating the thermal storage unit of, for example, FIGS. 1A and/or 1B, in accordance with some embodiments of the present invention;

FIG. 9A is a block diagram of a thermal storage system incorporating an array of thermal storage units configured to provide process heat for one or more industrial process(es), in accordance with some embodiments of the present invention;

FIG. 9B provides a schematic diagram of a cutaway view of a portion of thermal storage system of FIG. 9A during use, in accordance with some embodiments of the present invention;

FIG. 10A provides a schematic diagram of a heat exchanger system that may be used with one or more of the thermal storage systems and/or thermal storage units described herein, in accordance with some embodiments of the present invention;

FIG. 10B provides a schematic diagram of a thermal storage system that includes the heat exchanger system of FIG. 10A, in accordance with some embodiments of the present invention;

FIG. 11A provides a schematic diagram of a thermophotovoltaic system that may be used with one or more of the thermal storage systems and/or thermal storage units described herein, in accordance with some embodiments of the present invention; and

FIG. 11B provides a schematic diagram of a thermal storage system that includes the thermophotovoltaic system of FIG. 11A, in accordance with some embodiments of the present invention.

Throughout the drawings, the same reference numerals, and characters, unless otherwise stated, are used to denote like features, elements, components, or portions of the illustrated embodiments. Moreover, while the subject invention will now be described in detail with reference to the drawings, the description is done in connection with the illustrative embodiments. It is intended that changes and modifications can be made to the described embodiments without departing from the true scope and spirit of the subject invention as defined by the appended claims.

### DETAILED DESCRIPTION

Industrial heat makes up 24% of global energy use. Right now, most of this energy comes from fossil fuel combustion. With the wide variety of renewable electricity sources available today, there is an opportunity to greatly reduce the current cost of, and emissions produced by, energy used for industrial heat. However, many renewable electricity sources are intermittent and cannot provide electricity consistently when needed continuously as required for much industrial manufacturing.

The systems, devices, and methods described herein may be used to generate and store heat so that it may be delivered consistently and reliably to one or more industrial processes or sub-processes using electricity instead of traditional fuel combustion. The substrates and thermal storage units disclosed herein may be electrically conductive so that, for example, they communicate electricity to one another for resistive heating of a set, or plurality, of substrates and/or thermal storage units.

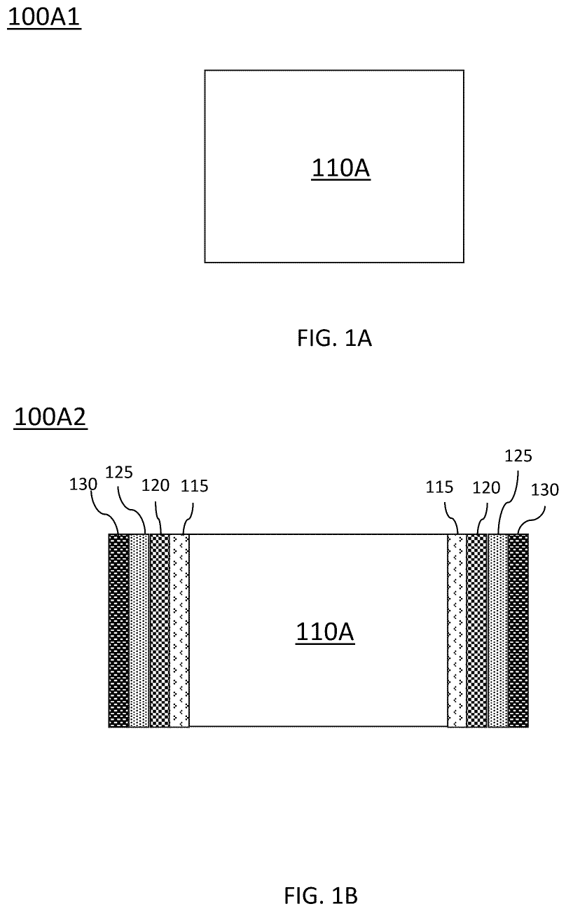

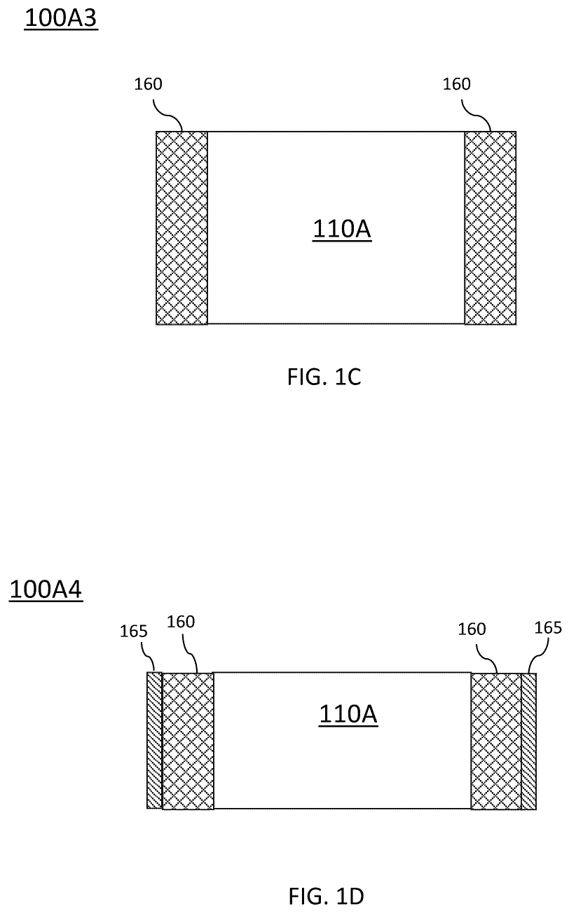

Turning now to the figures, FIG. 1A provides a schematic diagram of a side view of an exemplary a first block-shaped thermal storage unit 100A1 that includes a first substrate 110A in the form of a block, brick, and/or rectangular cuboid and may have dimensions of within an approximate range of 5-10 cm by 10-100 cm by 10-100 cm.

First substrate 110A may comprise and/or be formed of a material that is electrically conductive and able to be resistively heated when, for example, electricity is applied thereto. Exemplary materials for first substrate 110A include, but are not limited to, pure silicon carbide (i.e., SiC) and/or a silicon carbide composite, that includes SiC mixed with another material that may enhance and/or optimize one or more properties (e.g., electrical conductivity, oxidation resistance, thermal expansion, heat capacity, and other properties) of first substrate 110A. Materials that are suitable for forming a composite with SiC include, but are not limited to, metals, carbon, and/or other high temperature ceramic materials, such as oxides, carbides, borides, nitrides, phosphates, silicates, silicides, and zirconates. Exemplary composite materials include, but are not limited to, SiC-carbide composites, SiC-oxide composites, and SiC-boride composites, such as SiC—C, SiC—B4C, SiC—Cr2O3, Sic—Al2O3, SiC—CeC2, SiC—CaO, and SiC—MgO. Additionally, or alternatively, first substrate 110A may include MgO—C, TiO2—C, Al2O3—C, and/or combinations thereof. The particles used to form first substrate 110A may have a particle size ranging between about 0.2-200 microns and may have a purity of about 70-99%. In some embodiments, first substrate 110A may have a density of 2.10-3.30 g/cm³ and/or a relative density of 70-99%. In some embodiments, first substrate 110A may be dense but not necessarily fully dense.

FIG. 1B provides a schematic diagram of a side view of an exemplary second block-shaped thermal storage unit 100A2 that includes first substrate 110A, a first coating layer 115, an optional second coating layer 120, an optional third coating layer 125, and an optional fourth coating layer 130, In some embodiments, one or more of first, second, third, and/or fourth coating layer(s) 115, 120, 125, and/or 130 may be optional and/or not present for second block-shaped thermal storage unit 100A2. For example, in some embodiments, thermal storage unit 100B may include only first, second, and fourth coating layer(s) 115, 120, and 130. Alternatively, second block-shaped thermal storage unit 100A2 may have more than four (e.g., 5, 6, 7, 8, 9, or 10) coating layers and each of these coating layers may have functions and/or compositions similar to, or different from, those of first, second, third, and/or fourth coating layer(s) 115, 120, 125, and/or 130.

First, second, third, and/or fourth coating layer(s) 115, 120, 125, and/or 130 may be configured to, for example, protect first substrate 110A from degradation as may occur under certain conditions (e.g., temperatures) and/or in certain environments. For example, above certain temperatures, materials included in first substrate 110A (e.g., SiC and/or SiC composite) may begin to degrade when exposed to, for example, air, argon gases, and/or hydrogen and first, second, third, and/or fourth coating layer(s) 115, 120, 125, and/or 130 may be configured to protect first substrate 110A from these environmental conditions, thereby allowing first substrate 110A (or material contained therein) to retain its electrical conductivity and function properly in the environments where it would otherwise fail.

In some embodiments, coating layer composition may be determined and/or selected using, for example, thermal expansion gradients (e.g., a gradient to match the thermal expansions between the substrate and one or more coating layers) and/or chemical stability gradients that indicate reactivity between different chemicals and/or layers. For example, in some embodiments, an outer coating layer may be reactive with SiC and this layer may be isolated from the SiC substrate by an intermediate layer that is less reactive with SiC so that the thermal storage unit is more chemically stable.

Each coating layer of first substrate 110A may provide advantages and/or unique properties to second block-shaped thermal storage unit 100A2. In some cases, a configuration (e.g., composition, thickness, etc.) of one or more of first, second, third, and/or fourth coating layer(s) 115, 120, 125, and/or 130 may be used alone or in conjunction with one another to optimize second block-shaped thermal storage unit 100A2 functioning, versatility, and/or lifespan. In some embodiments each of first, second, third, and/or fourth coating layer(s) 115, 120, 125, and/or 130 may be configured to perform a separate function (e.g., thermal protection, oxidation inhibition, environmental degradation, electricity conduction, etc.). Alternatively, two or more of first, second, third, and/or fourth coating layer(s) 115, 120, 125, and/or 130 may be configured to perform similar functions. In some embodiments, two or more of first, second, third, and/or fourth coating layer(s) 115, 120, 125, and/or 130 may be similarly configured and/or comprise the same material. For example, in some embodiments, fourth layer 130 may comprise an oxide, third layer 125 may comprise an oxide/silicate composite, second layer 120 may comprise a silicate, and first layer 115 may comprise silicon.

Additionally, or alternatively, materials with different properties may be combined to make one or more multi-purpose layer(s) 160 as shown in FIG. 1C, which provides a schematic diagram of a side view of an exemplary third block-shaped thermal storage unit 100A3 that includes first substrate 110A and a multi-purpose layer 160.

In some embodiments, a third block-shaped thermal storage unit 100A3 may include one or more single component and/or single purpose layers (e.g., first, second, third, and/or fourth coating layer(s) 115, 120, 125, and/or 130) and one or more multi-purpose layers 160. For example, an exemplary fourth block-shaped thermal storage unit 100A4 has a multi-purpose layer 160 and an outer layer 165 as shown in FIG. 1D, which provides a schematic diagram of a side view of fourth block-shaped thermal storage unit 100A4 that includes first substrate 110A, multi-purpose layer 160, and a single purpose layer 165. In some instances, single purpose layer 165 may be similar to first, second, third, and/or fourth coating layer(s) 115, 120, 125, and/or 130.

In some embodiments, first, second, third, and/or fourth coating layer(s) 115, 120, 125, and/or 130, multi-purpose layer 160, and/or single purpose layer 165 may be configured to behave as, for example, a protective coating, one or more intermedial coating layers, and a bonding coating layer. The protective coating layer may be configured to, for example, protect a thermal storage unit from degradation in one or more environments. For example, a protective layer coating may comprise oxidation resistant materials such as oxides, silicates, and/or phosphates. The intermediate coating layers may be configured to, for example, provide thermal expansion and/or chemical stability between materials comprising second, third, and/or fourth block-shaped thermal storage unit(s) 100A2, 100A3, and/or 100A4. A bonding agent coating layer may be configured to assist with providing and/or ensuring good contact between first substrate 110A and other coating layers (e.g., the intermediate and/or protective layer coating(s)). Exemplary boding agent coating layers may comprise silicon. For example, in one embodiment, first coating layer 115 may be a bonding coating layer, second and third coating layers 120 and 125 may be intermediate layers, and fourth layer 130 may be a protective layer.

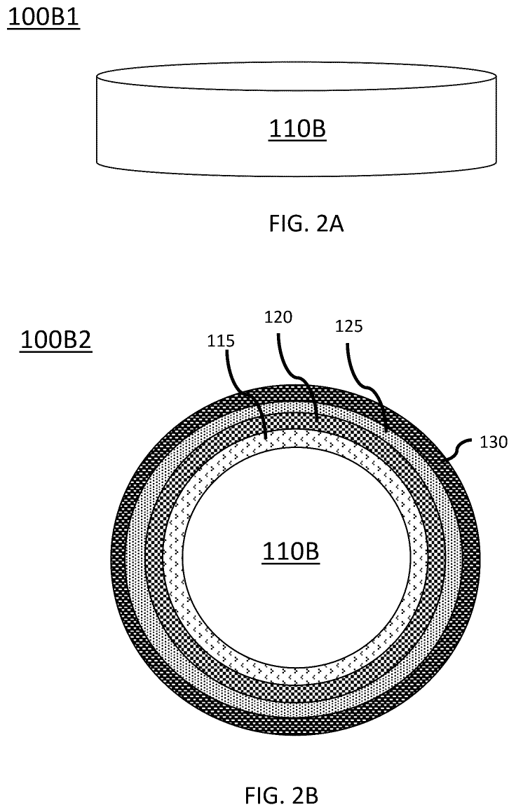

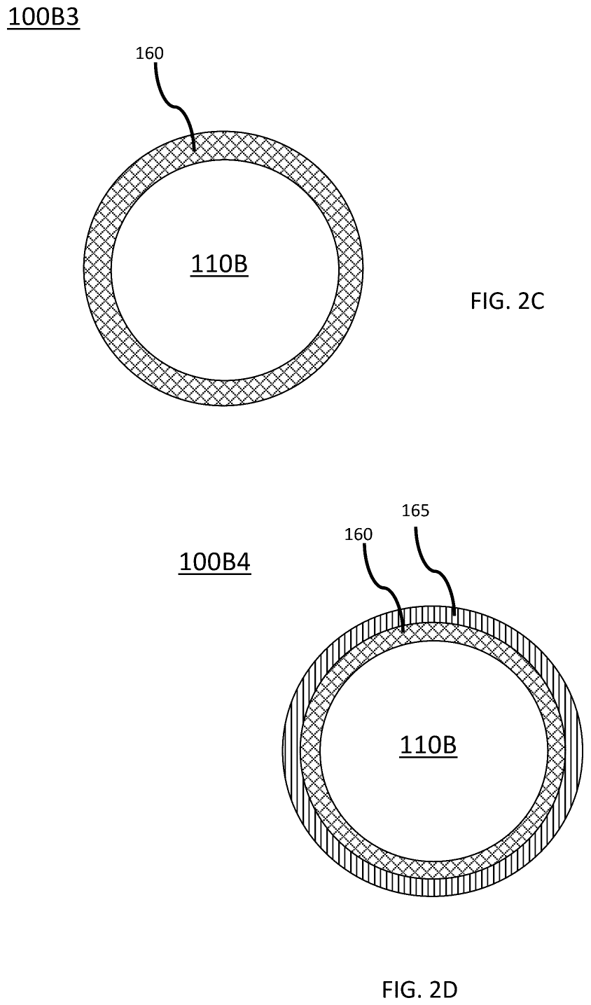

FIGS. 2A-2D provide schematic diagrams of side views of a plurality of different cylindrically-shaped thermal storage units that have a truncated cylindrical, or disk-like, shape. In particular, FIG. 2A provides a schematic diagram of a top-perspective view of a first cylindrically-shaped thermal storage unit 100B1 comprising a cylindrical substrate 110B with no coating layers. FIG. 2B provides a schematic diagram of a top view of a second cylindrically-shaped thermal storage unit 100B2 comprising cylindrical substrate 110B and first, second, third, and fourth coating layer(s) 115, 120, 125, and 130, wherein first coating layer 115 is applied to an outer surface of substrate 110B, second coating layer 120 is applied to an outer surface of first coating layer 115, third coating layer 125 is applied to an outer surface of second coating layer 130, and fourth coating layer 130 is applied to an outer surface of third coating layer 125 as shown in FIG. 2B. In some embodiments, the coating layers of second cylindrically-shaped thermal storage unit 100B2 may be similar to those of second block-shaped thermal storage unit 100A2. Additionally, or alternatively, second cylindrically-shaped thermal storage unit 100B2 may function and/or be manufactured in a manner similar to second block-shaped thermal storage unit 100A2.

FIG. 2C provides a schematic diagram of a top view of a third cylindrically-shaped thermal storage unit 100B3 comprising cylindrical substrate 110B and multi-purpose coating layer 160. Multi-purpose coating layer 160 is applied to an exterior surface of cylindrically-shaped substrate 110B in a manner similar to third block-shaped substrate 110A3 as shown in FIG. 1C. Additionally, or alternatively, third cylindrically-shaped thermal storage unit 100B3 may function and/or be manufactured in a manner similar to third block-shaped thermal storage unit 100A3.

FIG. 2D provides a schematic diagram of a top view of a fourth cylindrically-shaped thermal storage unit 100B4 comprising cylindrical substrate 110B, multi-purpose coating layer 160, and single purpose layer 165. Multi-purpose coating layer 160 and single purpose layer 165 is applied to an exterior surface of cylindrically-shaped substrate 110B in a manner similar to fourth block-shaped substrate 110A4 as shown in FIG. 1D. Additionally, or alternatively, fourth cylindrically-shaped thermal storage unit 100B4 may function and/or be manufactured in a manner similar to fourth block-shaped thermal storage unit 100A4.

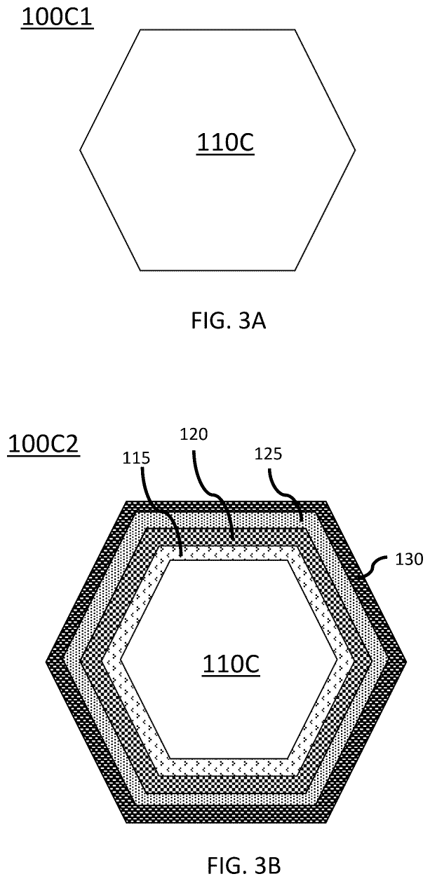

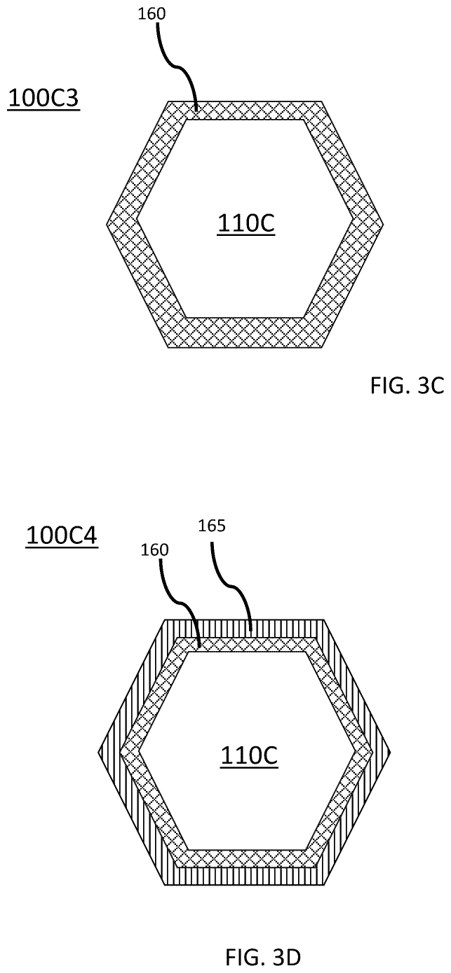

FIGS. 3A-3D provide schematic diagrams of side views of a plurality of different hexagonally-shaped thermal storage units that have a hexagonal (i.e., six-sided) shape. In particular, FIG. 3A provides a schematic diagram of a top-perspective view of a first hexagonally-shaped thermal storage unit 100C1 comprising a hexagonal substrate 110C with no coating layers. FIG. 3B provides a schematic diagram of a top view of a second hexagonally-shaped thermal storage unit 100C2 comprising hexagonal substrate 110C and first, second, third, and fourth coating layer(s) 115, 120, 125, and 130 applied to an outer perimeter (i.e., not the top or bottom) of hexagonal substrate 100C, wherein first coating layer 115 is applied to an outer surface of substrate 110C, second coating layer 120 is applied to an outer surface of first coating layer 115, third coating layer 125 is applied to an outer surface of second coating layer 130, and fourth coating layer 130 is applied to an outer surface of third coating layer 125 as shown in FIG. 3B. In some embodiments, the coating layers of second hexagonally-shaped thermal storage unit 100C2 may be similar to those of second block-shaped thermal storage unit 100A2 and/or second cylindrically-shaped thermal storage unit 100B2. Additionally, or alternatively, second hexagonally-shaped thermal storage unit 100C2 may function and/or be manufactured in a manner similar to second block-shaped thermal storage unit 100A2 and/or second cylindrically-shaped thermal storage unit 100B2.

FIG. 3C provides a schematic diagram of a top view of a third hexagonally-shaped thermal storage unit 100C3 comprising hexagonal substrate 110C and multi-purpose coating layer 160 applied to an outer perimeter (i.e., not the top or bottom) of hexagonal substrate 100C. Multi-purpose coating layer 160 is applied to an exterior surface of hexagonally-shaped substrate 110C in a manner similar to third block-shaped substrate 110A3 as shown in FIG. 1C and/or third cylindrically-shaped thermal storage unit 100B3. Additionally, or alternatively, third hexagonally-shaped thermal storage unit 100C3 may function and/or be manufactured in a manner similar to third block-shaped thermal storage unit 100A3 and/or third cylindrically-shaped thermal storage unit 100B3.

FIG. 3D provides a schematic diagram of a top view of a fourth hexagonally-shaped thermal storage unit 100C4 comprising hexagonal substrate 110C, multi-purpose coating layer 160, and single purpose layer 165 applied to an outer perimeter (i.e., not the top or bottom) of hexagonal substrate 100C. Multi-purpose coating layer 160 and single purpose layer 165 is applied to an exterior surface of hexagonally-shaped substrate 110C in a manner similar to fourth block-shaped substrate 110A4 as shown in FIG. 1D and/or fourth cylindrically-shaped thermal storage unit 100B4. Additionally, or alternatively, fourth hexagonally-shaped thermal storage unit 100C4 may function and/or be manufactured in a manner similar to fourth block-shaped thermal storage unit 100A4 and/or fourth cylindrically-shaped thermal storage unit 100B4.

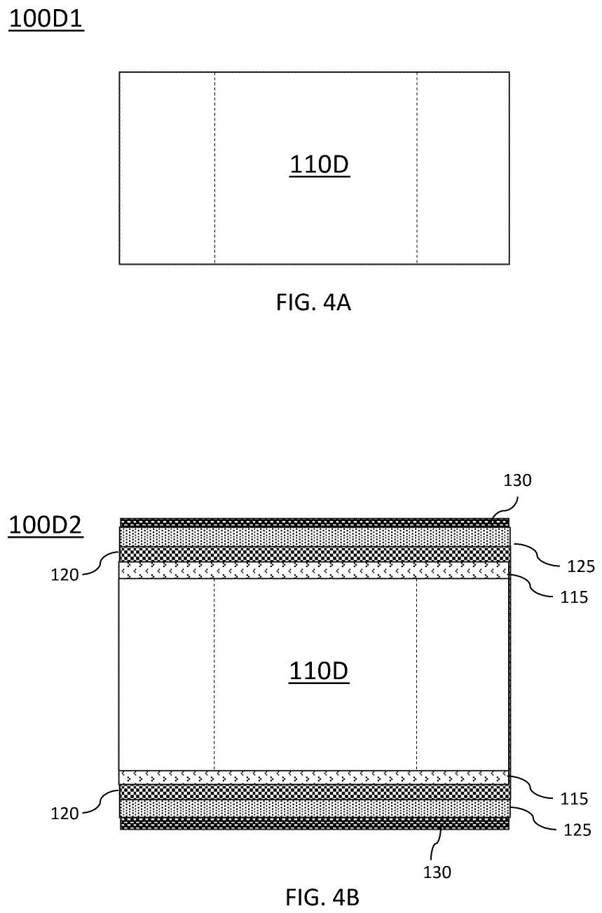

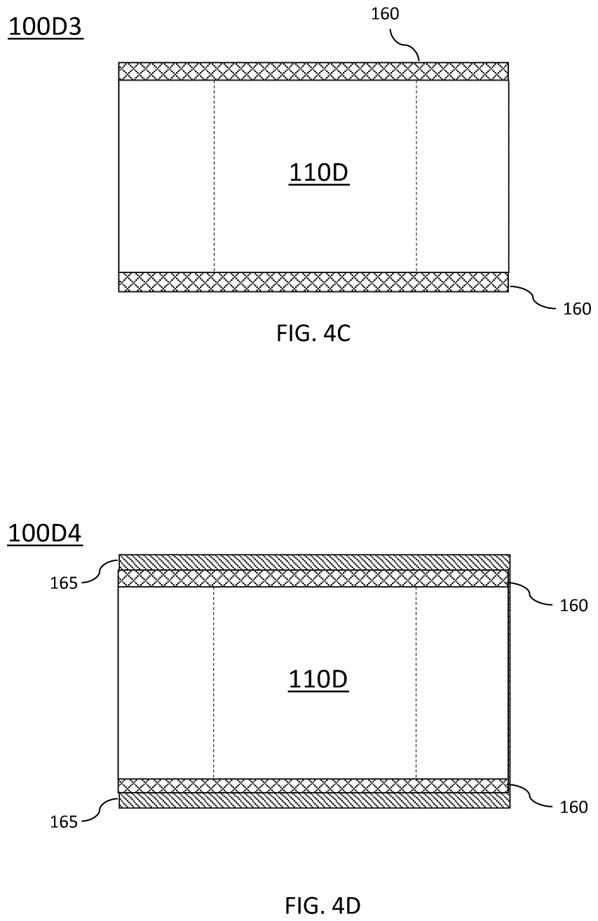

FIGS. 4A-4D provide schematic diagrams of side views of a plurality of different hexagonally-shaped thermal storage units that have a hexagonal (i.e., six-sided) shape. In particular, FIG. 4A provides a schematic diagram of a side view of a first hexagonally-shaped thermal storage unit 100D1 comprising a hexagonal substrate 110D with no coating layers. FIG. 4B provides a schematic diagram of a side view of a second hexagonally-shaped thermal storage unit 100D2 comprising hexagonal substrate 110D and first, second, third, and fourth coating layer(s) 115, 120, 125, and 130 applied to the top and bottom (as oriented in the figure) of hexagonal substrate 100D, wherein first coating layer 115 is applied to an outer surface of substrate 110D, second coating layer 120 is applied to an outer surface of first coating layer 115, third coating layer 125 is applied to an outer surface of second coating layer 130, and fourth coating layer 130 is applied to an outer surface of third coating layer 125 as shown in FIG. 4B. In some embodiments, the coating layers of second hexagonally-shaped thermal storage unit 100D2 may be similar to those of second block-shaped thermal storage unit 100A2, and/or second cylindrically-shaped thermal storage unit 100B2. Additionally, or alternatively, second hexagonally-shaped thermal storage unit 100D2 may function and/or be manufactured in a manner similar to second block-shaped thermal storage unit 100A2 and/or second cylindrically-shaped thermal storage unit 100B2.

FIG. 4C provides a schematic diagram of a side view of a third hexagonally-shaped thermal storage unit 100D3 comprising hexagonal substrate 110D and multi-purpose coating layer 160 applied to the top and bottom (as oriented in the figure) of hexagonal substrate 100D. Multi-purpose coating layer 160 is applied to an exterior surface of hexagonally-shaped substrate 110D in a manner similar to third block-shaped substrate 110A3 as shown in FIG. 1C and/or third cylindrically-shaped thermal storage unit 100B3. Additionally, or alternatively, third hexagonally-shaped thermal storage unit 100D3 may function and/or be manufactured in a manner similar to third block-shaped thermal storage unit 100A3 and/or third cylindrically-shaped thermal storage unit 100B3.

FIG. 4D provides a schematic diagram of a side view of a fourth hexagonally-shaped thermal storage unit 100D4 comprising hexagonal substrate 110D, multi-purpose coating layer 160, and single purpose layer 165 applied to top and bottom (as oriented in the figure) of hexagonal substrate 100D. Multi-purpose coating layer 160 and single purpose layer 165 is applied to an exterior surface of hexagonally-shaped substrate 110D in a manner similar to fourth block-shaped substrate 110A4 as shown in FIG. 1D and/or fourth cylindrically-shaped thermal storage unit 100B4. Additionally, or alternatively, fourth hexagonally-shaped thermal storage unit 100D4 may function and/or be manufactured in a manner similar to fourth block-shaped thermal storage unit 100A4 and/or fourth cylindrically-shaped thermal storage unit 100B4.

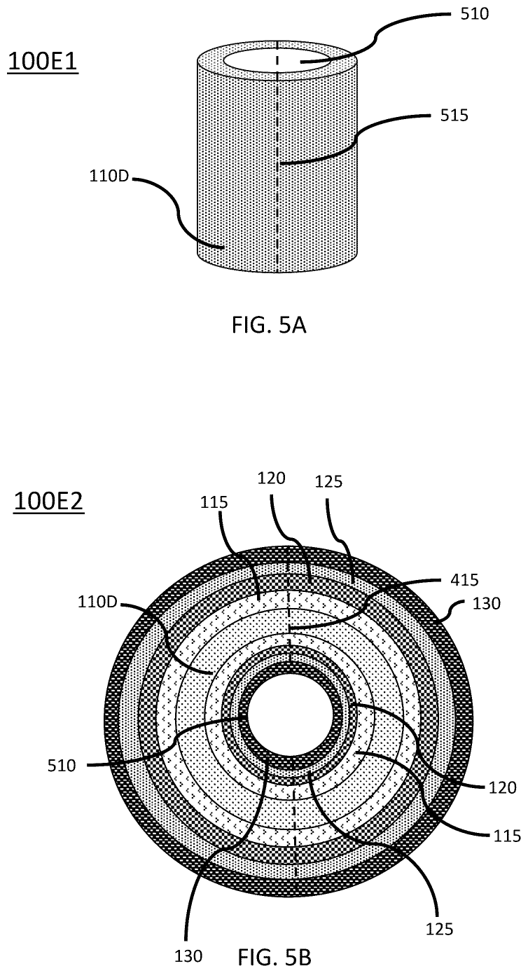

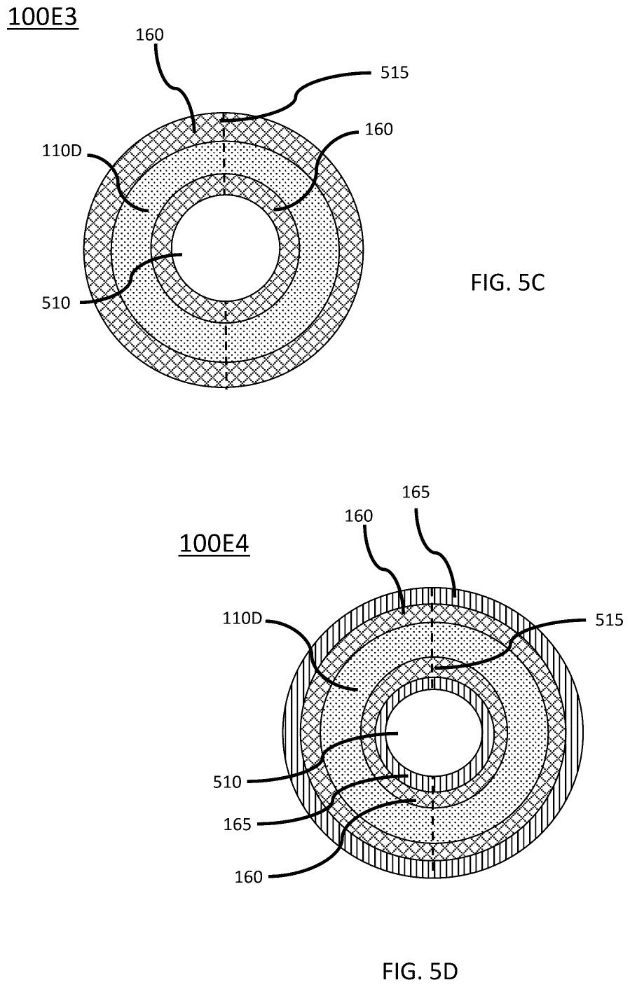

FIGS. 5A-5D provide schematic diagrams of side views of a plurality of different tube-shaped thermal storage units that have a tubular (i.e., a cylinder with a central aperture or lumen) shape. In particular, FIG. 5A provides a schematic diagram of a top-perspective view of a first tube-shaped thermal storage unit 100E1 comprising a tube substrate 110D with no coating layers. Tube substrate 110C includes a central lumen 510 that may be open to the environment.

In some embodiments, tube substrate 110C may comprise two pieces with a semi-circular cross section that may be assembled together to create tube substrate 110C as shown in FIG. 5A. In these embodiments, tube substrate 110C may include a seem 515, or joint, positioned where the two halves are tube substrate 110C are assembled together. Use of two pieces with a semi-circular cross section for tube substrate 110C may facilitate even and efficient application of one or more coating layers to lumen 510 as shown in, for example, FIGS. 5B-5D and discussed below.

FIG. 5B provides a schematic diagram of a top view of a second tube-shaped thermal storage unit 100E2 comprising tube substrate 110C and first, second, third, and fourth coating layer(s) 115, 120, 125, and 130, wherein first coating layer 115 is applied to an outer and inner surface of substrate 110C, second coating layer 120 is applied to an outer and inner surface of first coating layer 115, third coating layer 125 is applied to an outer and inner surface of second coating layer 130, and fourth coating layer 130 is applied to an outer and inner surface of third coating layer 125 as shown in FIG. 5B.

In some embodiments, the coating layers of second tube-shaped thermal storage unit 100E2 may be similar to those of second block-shaped thermal storage unit 100A2 and/or second cylindrically-shaped thermal storage unit 100B2. Additionally, or alternatively, second tube-shaped thermal storage unit 100E2 may function and/or be manufactured in a manner similar to second block-shaped thermal storage unit 100A2 and/or second cylindrically-shaped thermal storage unit 100B2. In some embodiments, one or more coating layers (e.g., first, second, third, and fourth coating layer(s) 115, 120, 125, and 130) may be applied to an exterior surface of lumen 510 (not shown).

FIG. 5C provides a schematic diagram of a top view of a third tube-shaped thermal storage unit 100E3 comprising tube substrate 110C and multi-purpose coating layer 160. Multi-purpose coating layer 160 is applied to an exterior surface of tube-shaped substrate 110C in a manner similar to third block-shaped substrate 110A3 as shown in FIG. 1C and/or cylindrically-shaped thermal storage unit 100B3. Additionally, or alternatively, third tube-shaped thermal storage unit 100E3 may function and/or be manufactured in a manner similar to third block-shaped thermal storage unit 100A3, third cylindrically-shaped thermal storage unit 100B3, and/or third hexagonally-shaped thermal storage unit 100C3.

FIG. 5D provides a schematic diagram of a top view of a fourth tube-shaped thermal storage units 100E4 comprising tube substrate 110C, multi-purpose coating layer 160, and single purpose layer 165. Multi-purpose coating layer 160 and single purpose layer 165 is applied to an exterior surface of tube-shaped substrate 110C in a manner similar to fourth block-shaped substrate 110A4, fourth cylindrically-shaped thermal storage unit 100B4, and/or fourth hexagonally-shaped thermal storage unit 100C4. Additionally, or alternatively, fourth tube-shaped thermal storage unit 100E4 may function and/or be manufactured in a manner similar to fourth block-shaped thermal storage unit 100A4, fourth cylindrically-shaped thermal storage unit 100B4, and/or fourth hexagonally-shaped thermal storage unit 100C4.

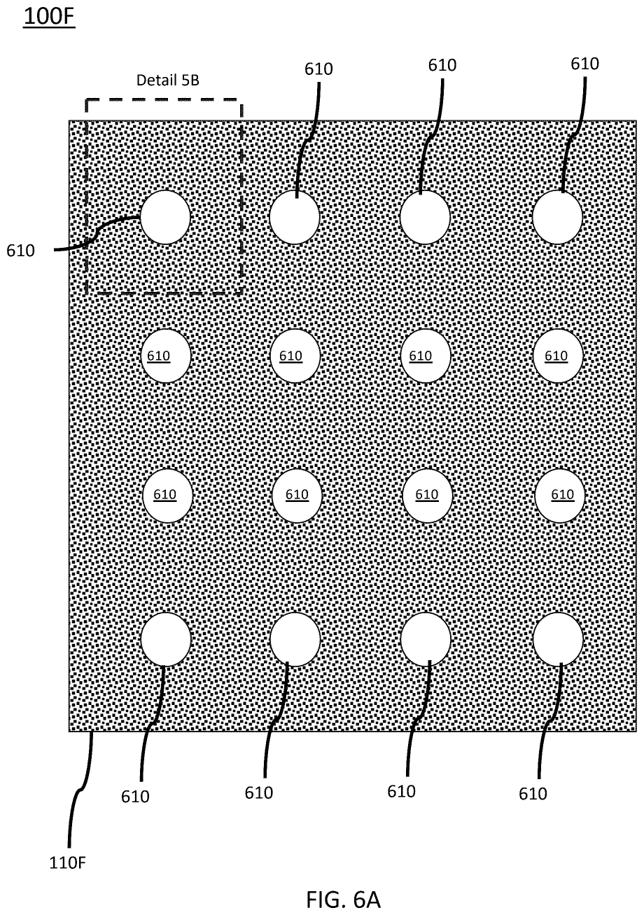

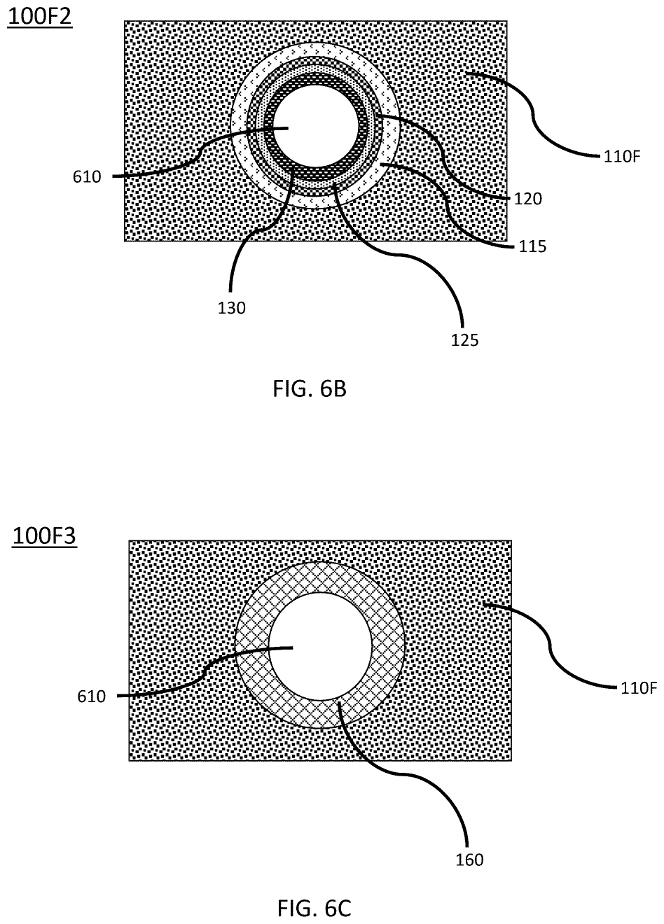

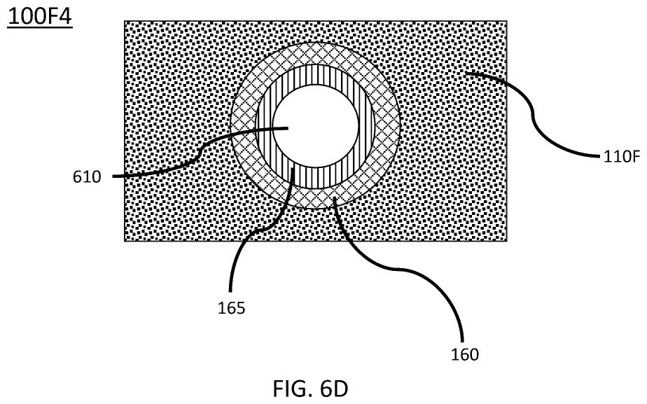

FIG. 6A provides a schematic diagram of a top view of a channeled thermal storage unit 100F1 that includes a substrate 110F with a plurality of channels 610 therein. Substrate 110F may be manufactured in a manner similar the other substrates disclosed herein and be molded to have channels 610 therein and/or may be modified to have channels 610 via, for example, drilling and/or processing of substrate 110F after formation. In some cases, one or more exterior sides of substrate 100F may be coated with one or more coating layers (not shown) as described herein with regard to, for example, FIG. 1B-1D. For example, the exterior surfaces of substrate 110F that do not expose channels 610 may be coated with one or more coating layers as, for example, shown in FIGS. 1B, 1C, and 1D. In this example, a plurality of substrates 100F may be configured to be arranged in a horizontally-oriented stack, side-by-side, so that uncoated ends may be in physical and/or electrical contact with other thermal storage units 100F while the channels of each substrate 100F of the stack are in communication with one another so that, for example, heat transfer fluid may travel through the channels arranged end-to-end.

Channels 610 of thermal storage unit 100F1 are uncoated but this need not always be the case. For example, one or more of channels 610 may be coated with one or more coating layers as described herein as shown in, for example, FIG. 6B, which is a detailed view of a second channeled thermal storage unit 100F2 with channels 610 that are coated with first, second, third, and/or fourth coating layers 115, 120, 125, and 130. In another example, a third channeled thermal storage unit 100F3 may include channels 610 that are coated with multi-purpose coating layer 160 as shown in FIG. 6C. Alternatively, a fourth channeled thermal storage unit 100F4 may include channels 610 that are coated with multi-purpose coating layer 160 and coating layer 165 as shown in FIG. 6D.

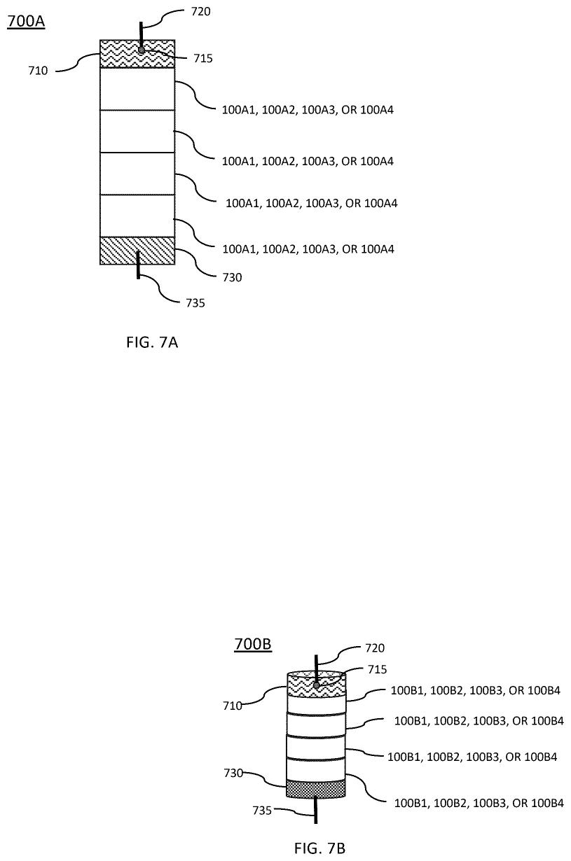

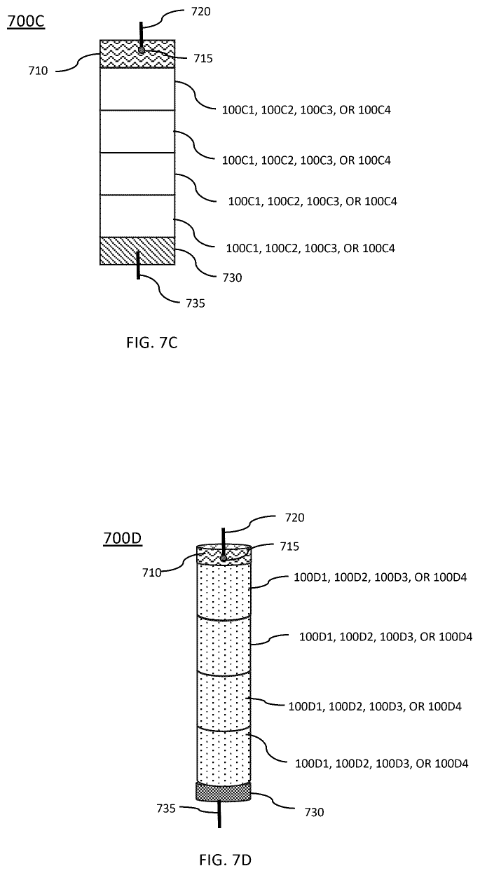

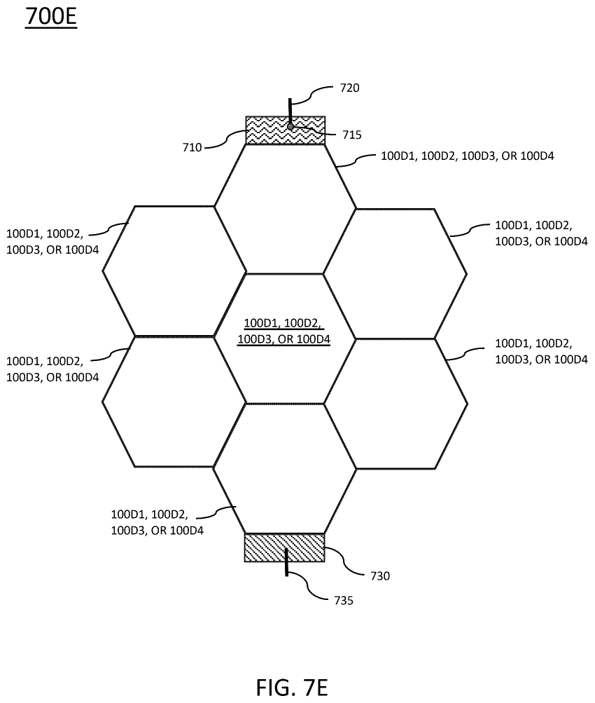

All of the thermal storage units described herein have at least two uncoated ends, which are often the top and bottom ends, that facilitate electrical connectivity between thermal storage units when they are positioned proximate to, and/or are stacked on top of one another. FIGS. 7A-7D provide schematic diagrams of side views of stacks of thermal storage units that are electrically, thermally, and, in some cases, physically coupled to one another. For example, FIG. 7A provides a schematic diagram of a side view of a stack 700A that includes a plurality (in this case, four) of first, second, third, and/or fourth block-shaped thermal storage units 100A1, 100A2, 100A3, and/or 100A4. In some embodiments, all of the thermal storage units of stack 700A will be the same (e.g., all fourth block-shaped thermal storage unit 100A4 or all first block-shaped thermal storage unit 100A1). Alternatively, stack 700A may include a variety of first, second, third, and/or fourth block-shaped thermal storage unit 100A1, 100A2, 100A3, and/or 100A4.

The plurality of block-shaped thermal storage units of stack 700A may be in electrical communication with one another via, for example, direct and/or indirect physical contact with one another. Stack 700A also includes an electricity communication plate 710 that includes an electrical lead 715 physically and electrically coupled to wiring 720 configured to electrically couple lead 715 to a power source. Stack 700A further includes a grounding plate 730 that is physically and electrically coupled to grounding wiring 735. Electricity communication plate 710 and/or electrical lead 715 more conductive than the plurality of block-shaped thermal storage units of stack 700A and, therefore, may generate minimal or no heat. Exemplary materials for electricity communication plate 710 and/or electrical lead 715 include, but are not limited to, metals (e.g., copper and/or tungsten) and/or other ceramics with conductivity higher than the block-shaped thermal storage unit(s) of stack 700A thermal storage unit 100.

During use, electricity is delivered to stack 700A via delivery from wiring 720 to electrical lead 715. The delivered electricity flows through the plurality of block-shaped thermal storage units of stack 700A and eventually exits stack 700A via grounding plate 730 and/or grounding wiring 735. As electricity flows through stack 700B, the block-shaped thermal storage units thereof become resistively heated.

FIG. 7B provides a schematic diagram of a side view of a stack 700B that includes a plurality (in this case, four) of first, second, third, and/or fourth cylindrically-shaped thermal storage units 100B1, 100B2, 100B3, and/or 100B4. In some embodiments, all of the thermal storage units of stack 700B will be the same (e.g., all fourth cylindrically-shaped thermal storage unit 100B4 or all first cylindrically-shaped thermal storage unit 100B1). Alternatively, stack 700B may include a variety of first, second, third, and/or fourth cylindrically-shaped thermal storage unit 100B1, 100B2, 100B3, and/or 100B4.

The plurality of cylindrically-shaped thermal storage units of stack 700B may be in electrical communication with one another via, for example, direct and/or indirect physical contact with one another. Stack 700B also includes electricity communication plate 710, electrical lead 715, wiring 720, grounding plate 730, and grounding wiring 735. During use, electricity is delivered to stack 700B via wiring 720 to electrical lead 715. The delivered electricity flows through the plurality of cylindrically-shaped thermal storage units of stack 700B and eventually exits stack 700B via grounding plate 730 and/or grounding wiring 735. As electricity flows through stack 700B, the cylindrically-shaped thermal storage units thereof become resistively heated.

FIG. 7C provides a schematic diagram of a side view of a stack 700C that includes a plurality (in this case, four) of first, second, third, and/or fourth hexagonally-shaped thermal storage units 100C1, 100C2, 100C3, and/or 100C4. In some embodiments, all of the thermal storage units of stack 700C will be the same (e.g., all fourth hexagonally-shaped thermal storage unit 100C4 or all first hexagonally-shaped thermal storage unit 100C1). Alternatively, stack 700C may include a variety of first, second, third, and/or fourth hexagonally-shaped thermal storage unit 100C1, 100C2, 100C3, and/or 100C4.

The plurality of hexagonally-shaped thermal storage units of stack 700C may be in electrical communication with one another via, for example, direct and/or indirect physical contact with one another. Stack 700C also includes electricity communication plate 710, electrical lead 715, wiring 720, grounding plate 730, and grounding wiring 735. During use, electricity is delivered to stack 700C via wiring 720 to electrical lead 715. The delivered electricity flows through the plurality of hexagonally-shaped thermal storage units of stack 700C and eventually exits stack 700C via grounding plate 730 and/or grounding wiring 735. As electricity flows through stack 700C, the hexagonally-shaped thermal storage units thereof become resistively heated.

FIG. 7D provides a schematic diagram of a side view of a stack 700D that includes a plurality (in this case, four) of first, second, third, and/or fourth tube-shaped thermal storage units 100E1, 100E2, 100E3, and/or 100E4. In some embodiments, all of the thermal storage units of stack 700D will be the same (e.g., all fourth tube-shaped thermal storage unit 100E4 or all first tube-shaped thermal storage unit 100E1). Alternatively, stack 700D may include a variety of first, second, third, and/or fourth tube-shaped thermal storage unit 100E1, 100E2, 100E3, and/or 100E4.

The plurality of tube-shaped thermal storage units of stack 700D may be in electrical communication with one another via, for example, direct and/or indirect physical contact with one another. Stack 700D also includes electricity communication plate 710, electrical lead 715, wiring 720, grounding plate 730, and grounding wiring 735. During use, electricity is delivered to stack 700D via wiring 720 to electrical lead 715. The delivered electricity flows through the plurality of tube-shaped thermal storage units of stack 700D and eventually exits stack 700D via grounding plate 730 and/or grounding wiring 735. As electricity flows through stack 700D, the tube-shaped thermal storage units thereof become resistively heated.

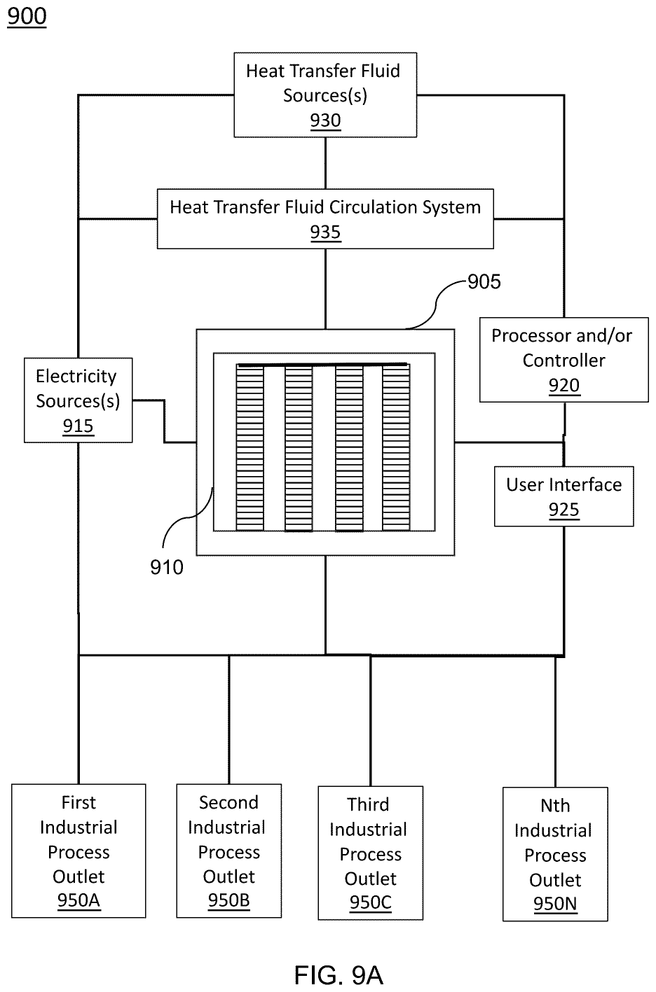

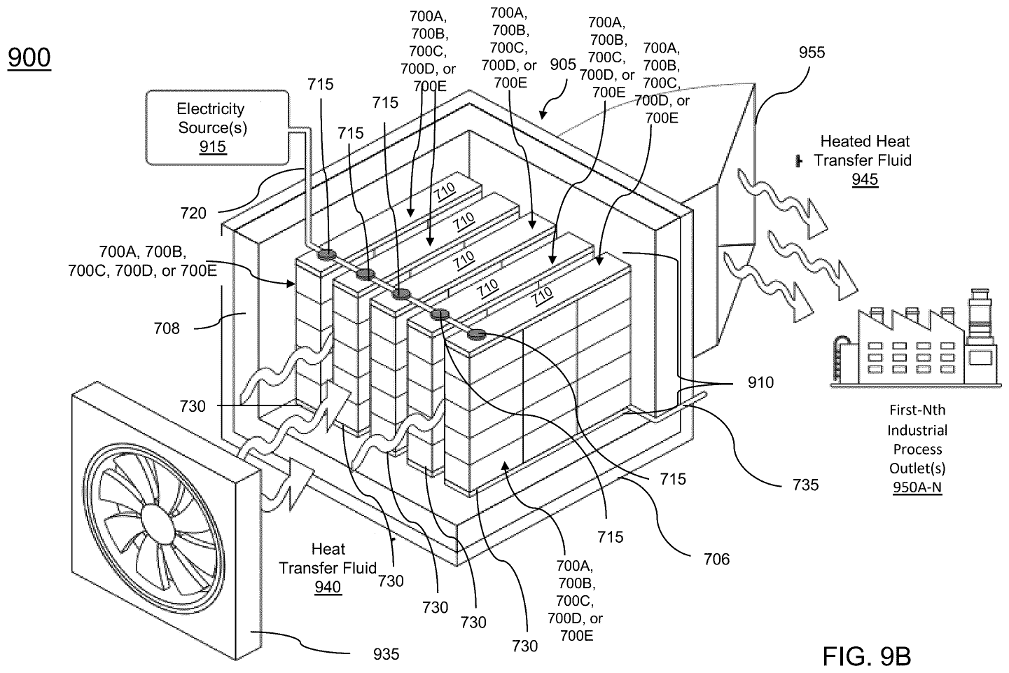

FIG. 7E a schematic diagram of a top view of a tessellation, or hexagonal grid 700E, of a plurality (in this case, seven) of hexagonally-shaped thermal storage units 100D1, 100D2, 100D3, and/or 100D4. The plurality of hexagonally-shaped thermal storage units 100D1, 100D2, 100D3, and/or 100D4 of tessellation 700E may be in electrical communication with one another via, for example, direct and/or indirect physical contact with one another. Tessellation 700E also includes electricity communication plate 710, electrical lead 715, wiring 720, grounding plate 730, and grounding wiring 735. During use, electricity is delivered to tessellation 700E via wiring 720 to electrical lead 715. The delivered electricity flows through the plurality of hexagonally-shaped thermal storage units 100D1, 100D2, 100D3, and/or 100D4 of tessellation 700E and eventually exits tessellation 700E via grounding plate 730 and/or grounding wiring 735. As electricity flows through tessellation 700E, the hexagonally-shaped thermal storage units thereof become resistively heated. During use, one or more layers of tessellation 700E may be arranged in a housing (e.g., housing 905 of FIG. 9A, discussed below) of a thermal storage system so that heat transfer fluid may flow over top and/or underneath the tessellations 700E.

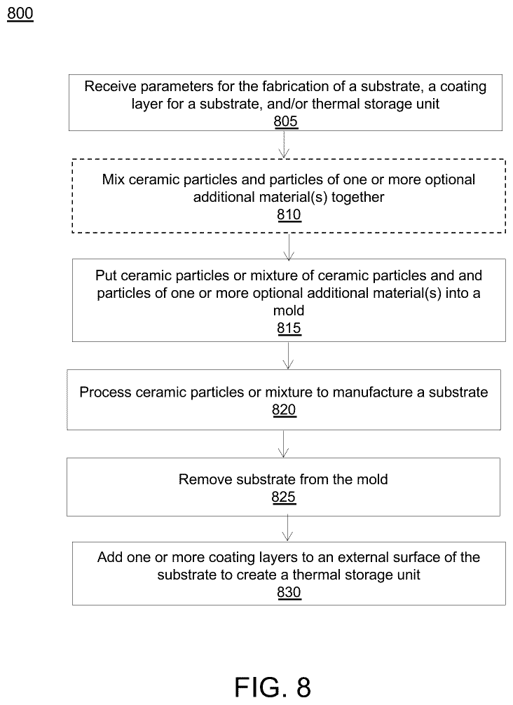

FIG. 8 is a flowchart illustrating an exemplary process 800 for the manufacturing of a substrate like first substrate 110A, cylindrical substrate 110B, hexagonal substrate 110C, and/or tube substrate 110D and/or a thermal storage unit like first, second, third, and/or fourth block-shaped thermal storage unit(s) 100A1, 100A2, 100A3, and/or 100A4, first, second, third, and/or fourth cylindrically-shaped thermal storage units 100B1, 100B2, 100B3, and/or 10BD4, first, second, third, and/or fourth hexagonally-shaped thermal storage units 100C1, 100C2, 100C3, and/or 100C4, and/or first, second, third, and/or fourth tube-shaped thermal storage units 100E1, 100E2, 100E3, and/or 100E4.

Process 800 may be executed by, for example, one or more processors, controllers, and/or computers interfacing with substrate and/or thermal storage unit manufacturing equipment as, for example, discussed herein.

Initially, in step 805, parameters for the fabrication of the substrate and/or a thermal storage unit may be received. The received parameters may be responsive to, for example, cost targets, maintenance requirements, use requirements, material properties, manufacturing processes, end use, customer requirements, manufacturing equipment to be used in fabricating the substrate and/or thermal storage unit, and/or compatibility of materials used to fabricate the substrate and/or a thermal storage unit. Exemplary parameters include, but are not limited to, material composition, material form (e.g., particle size and/or state of matter), substrate dimensions, substrate density, substrate form factor (e.g., block, disk, hexagon, tube, rod, etc.), substrate thermal capacity substrate, parameters for equipment used to fabricate the substrate, coating layer type, coating layer composition, coating layer placement (e.g., first, second, third, etc.), method of applying the coating, and/or parameters (e.g., temperature, velocity of coating being sprayed on the substrate, etc.) for operating coating layer application equipment.

In one example, parameters received in step 805 include a particular type of ceramic material (e.g., SiC) to be used for substrate fabrication and, in some cases, a size of the particles to be used to fabricate the substrate. Often times, particle size for the ceramic material is within a range of about 0.2-200 microns or 0.2-100 microns and, on some occasions, the ceramic particles may be ball milled prior to use so that they are of a specific size and/or within a range of sizes. Optionally, the parameters received in step 805 may also include a particular type of additional material to add to the ceramic material so that the substrate generated via execution of process 800 may be a composite of the ceramic and additional material. Often the additional material is also in particle form, wherein the particles may be within a range of about 0.2-200 microns or 0.2-100 microns. Exemplary additional materials that may be used in addition to the ceramic material include, for example, carbon or other high temperature ceramic materials, such as oxides, carbides, borides, nitrides, phosphates, silicates, silicides, zirconates, and/or combinations thereof. As with the ceramic particles, the particles of additional material may be ball milled prior to use to ensure particles of a particular size and/or within a set range of sizes.

In some embodiments, one or more parameters (e.g., type of material, thickness of the material, proximity to other materials (e.g., substrate and/or other coating layers) for a coating layer may be received in step 805. Selection of these parameters may incorporate analysis of material compatibility and/or potential thermal expansion mismatch between a material comprising the substrate and one or more of coating layers (e.g., first, second, third, and/or fourth coating layer(s) 115, 120, 125, and/or 130, multi-purpose coating layer 160, and/or coating layer 165) to, for example, optimize performance and/or lifespan of a thermal storage unit like thermal storage unit 100 and/or reduce manufacturing costs and/or complexity. Determining compatibility for substrate and coating layers and/or between coating layers may be performed using, for example, percent thermal expansion mismatch values for various substrate and coating layer materials, such as those provided in Table 1, below. Additionally, or alternatively, in some embodiments, compatibility determinations may be made using a software program like LayerSlayer Mulitlayer Analysis Suite.

TABLE 1

| | SiC—C | SiC | SiC—B₄C | SiC—Cr₂O₃ | SiC—Al₂O₃ | SiC—ZrO₂ | SiC—CeO₂ | SiC—CaO | SiC—MgO |
|---|---|---|---|---|---|---|---|---|---|
| Al₂O₃ | 90 | 58 | 43 | 50 | 15 | 7 | 10 | 26 | 34 |
| ZrO₂ | 150 | 106 | 88 | 71 | 51 | 22 | 18 | 5 | 13 |
| Al₂O₃ | 90 | 58 | 43 | 30 | 15 | 7 | 10 | 28 | 31 |
| CeO₂ | 160 | 117 | 95 | 78 | 57 | 27 | 23 | 1 | 10 |
| CeO | 240 | 183 | 156 | 133 | 108 | 65 | 61 | 29 | 18 |
| MgO | 280 | 217 | 186 | 58 | 130 | 86 | 80 | 144 | 31 |
| Cr₂O₃ | 60 | 33 | 20 | 90 | 3 | 22 | 24 | 39 | 45 |
| Mullite | 40 | 17 | 5 | 4 | 15 | 32 | 34 | 47 | 52 |
| TiO₂ | 52 | 27 | 14 | 4 | 8 | 26 | 28 | 42 | 47 |
| BaZrO₃ | 50 | 25 | 13 | 3 | 9 | 27 | 29 | 42 | 49 |
| MoSi₂ | 70 | 42 | 28 | 16 | 3 | 17 | 19 | 35 | 41 |
| YPO₄ | 20 | 0 | 10 | 18 | 27 | 41 | 43 | 54 | 58 |
| YbPO₄ | 20 | 0 | 10 | 18 | 27 | 41 | 43 | 54 | 58 |
| ErPO₄ | 20 | 0 | 10 | 18 | 27 | 41 | 43 | 54 | 58 |
| Yb₂Si₂O₇ | 20 | 33 | 40 | 45 | 52 | 51 | 62 | 70 | 72 |
| 7YSZ | 100 | 67 | 50 | 37 | 20 | 2 | 5 | 24 | 31 |
| Yb₂SiO₅ | 60 | 33 | 20 | 10 | 3 | 22 | 24 | 39 | 35 |
| Y₂SiO₅ | 60 | 33 | 20 | 10 | 3 | 22 | 24 | 39 | 35 |
| Cr₂SiO₅ | 30 | 8 | 2 | 11 | 21 | 36 | 38 | 51 | 55 |
| Yb₂O₃ | 80 | 50 | 35 | 23 | 9 | 12 | 15 | 32 | 38 |
| Y₂O₃ | 80 | 50 | 35 | 23 | 9 | 12 | 15 | 32 | 38 |
| Na₂SiO₅ | 100 | 67 | 30 | 37 | 21 | 2 | 5 | 24 | 31 |
| Ta₂O₅ | 20 | 33 | 40 | 45 | 52 | 61 | 62 | 70 | 72 |
| Y₂Si₂O₇ | 40 | 50 | 55 | 59 | 64 | 71 | 72 | 77 | 79 |

The percent thermal expansion mismatch values of Table 1 were determined analytically using known values for thermal expansion. Generally, substrate and coating layer materials having a mismatch of =<10% have the best compatibility, those with a mismatch of =11-20% have good compatibility, and those with a mismatch of =>20% have a greater mismatch and are not compatible. For example, a SiC substrate material with a coating of YPO₄, YbPO₄, or ErPO₄ would show 0% mismatch and have excellent compatibility.

One of the parameters received in step 805 may include substrate thickness, which is of particular importance because it contributes to temperature regulation throughout the substrate. When substrates are too thick, or too thin, uneven heating, thermal runaway, and/or localized hot spots can occur, which lead to inefficiencies and substrate/system failure. Even small temperature imbalances within a substrate may be problematic because they may be amplified across successive charge-discharge cycles so that, after several cycles, even small imbalances may result in large temperature differences which may be damaging to substrates and/or heaters, and/or severely limit the temperature range within which the system can be safely operated.

By carefully setting substrate thickness, these issues may be controlled and/or mitigated. One way to select and/or determine substrate thickness may involve analysis of a relative Temperature Coefficient of Conductivity (TCC) magnitude and/or thermal conductivity (also referred to herein as “K”) for one or more materials used to manufacture the substrate and/or thermal storage unit. The TCC magnitude is a metric by which to understand temperature imbalances within a substrate and/or thermal storage unit to, for example, assess stability and safety during charging and/or use. For example, if random fluctuations produce a hot spot during charging, a sufficiently large positive or negative TCC will cause local heat generation to intensify in a positive feedback loop leading to thermal runaway and catastrophic failure. The TCC magnitude's sign (i.e., + or −) determines whether risks caused by temperature imbalances are associated with parallel or series current flow, both of which exist in 3D heated substrates like substrate 110. Substrates composed of composites have a slightly positive TCC magnitude, putting them at risk of failure in parallel configurations. However, a small TCC magnitude can still be tolerated if heat passively conducts away from the hot spot faster than it is generated.

Based on the composites' measured K and TCC, the maximum allowable block thickness (also referred to herein as “Lsafemax”) may be determined. The Lsafemax may correspond to the thickness of a substrate below which heat will conduct away fast enough to prevent thermal runaway for hot spots of any size. For example, a Lsafemax for the composite TiO2+Gr is 9 cm and a Lsafemax for the composite SiC+Gr is 17 cm in a direction perpendicular to electrical current flow.

Optionally, when one or more additional material(s) are being used to fabricate a ceramic composite substrate, particles of the one or more additional material(s) may be mixed with the ceramic particles to, for example, generate a homogenous mixture (step 810). In step 815, the ceramic particles, or when step 810 is executed the homogenous mixture of particles may then be placed within a mold for the substrate according to the received parameters.

In step 820, the ceramic particles or homogenous mixture of particles may be processed according to, for example, the parameters of step 805, to manufacture, or generate the substrate. Often the processing of step 820 involves compressing, heating, and/or sintering the ceramic particles or homogenous mixture of particles within the mold. In one example, process 820 may be executed by compressing (using, for example, a hydraulic press) the ceramic particles or homogenous mixture of particles within the mold to form a compressed solid. The compressed solid may then be sintered using, for example, pressure-less sintering process. Additionally, or alternatively, step 820 may be executed by sintering or heating the compressed solid to about 1800-2200° C. at a pressure of approximately 50-250 MPa. Additionally, or alternatively, the substrate may be formed by pressing the ceramic particles and, when used, particles of additional material(s) within a mold using a hot press that applies approximately 15-170 MPa of pressure at a temperature within a range of 1600-2000° C. Additionally, or alternatively, step 820 may be executed by pressing the ceramic particles or homogenous mixture of particles within the mold and using a spark plasma sintering process to heat the particles to a temperature within a range of 1600-2000° C. while applying pressure within a range of 40-100 MPa. When the manufacturing process (i.e., step 820) is complete, the substrate 110 may be removed from the mold (step 825). In some embodiments, the substrate removed from the mold may have a density within a range of approximately 2.10-3.30 g/cm³ or a relative density within a range of 70-99%.

In step 830, one or more coating layers (e.g., first, second, third, and/or fourth coating layer(s) 115, 120, 125, and/or 130, multipurpose coating layer 160, and/or coating layer 165) may be applied to one or more external surfaces (e.g., top, bottom, front, back, left side, and/or right side) of the unmolded substrate. In many instances, the coating layer(s) will not be applied to two opposing surfaces of a substrate so that, for example, electricity may flow between a plurality of substrates that are stacked (e.g., stacks 700A, 700B, 700C, and/or 700D) so that their uncoated sides are touching one another. For example, a top and a bottom (as oriented in FIGS. 1B-1D, 2B, and 4A) of for example, second, third, and/or fourth block-shaped thermal storage unit(s) 100A2, 100A3, and/or 100A4, second, third, and/or fourth cylindrically-shaped thermal storage units 100B2, 100B3, and/or 10BD4, second, third, and/or fourth hexagonally-shaped thermal storage units 100C2, 100C3, and/or 100C4, and/or second, third, and/or fourth tube-shaped thermal storage units 100E2, 100E3, and/or 100E4.

In some embodiments, the coating layer(s) may comprise and/or be made using a coating layer powder that is sprayed onto an exterior surface of the substrate and/or an existing coating layer through an Atmospheric Plasma Spray (APS) coating process, wherein the coating layer powder is injected into a stream of high-temperature plasma, which melts and/or liquifies the coating layer powder and then accelerates the molten coating material toward an external surface of the substrate and/or a previously applied coating layer. Once applied to the substrate, the molten coating material may re-solidify, thereby creating the coating. In some embodiments, the coating layer powder may be applied by an APS coating process operating at a power ranging between 20-50kW, a current ranging between 700-1000 A, a coating layer powder feed rate ranging between 10-50 g/min, an argon flow rate ranging between 20-60 L/Min, and/or an H₂ flow rate ranging 1-6 L/min. In some instances, the APS coating process may further include a carrier argon flow rate that is within a range of 2-6 L/m, a spraying distance within a range of 50-200 mm, and/or a gun traverse speed within a range of 200-1000 mm/s. These APS coating process parameters are exemplary and may vary responsively to, for example, coating material, substrate material, desired parameters for a thermal storage unit, and/or desired parameters for a system utilizing a thermal storage unit. In some embodiments, a thickness of a coating resulting from execution of step 830 may be within a range of 25-700 microns and may have a relative density of about 70-99.9% using particles within a size range of 0.2-100 microns. In some embodiments, step 830 may be repeated to, for example, apply multiple layers to an external surface of the substrate. In some embodiments, step 830 may be repeated to apply multiple layers of a single and/or different coating materials to, for example, manufacture one or more of the thermal storage units disclosed herein.

FIG. 9A provides a block diagram of a thermal storage system 900 and FIG. 9B provides a schematic diagram of a cutaway view of thermal storage system 900 during use. Thermal storage system 900 includes a housing 905 for housing an array 910 of thermal storage units 100, one or more electricity source(s) 915, a processor and/or controller 920, a user interface 925, heat transfer fluid source(s) 930, a heat transfer fluid circulation system 935, and a plurality (A-N) of industrial process outlets 950, which are represented in FIG. 9A as a first industrial process outlet 950A, a second industrial process outlet 950B, a third industrial process outlet 950C, and an Nth industrial process outlet 950N. In some embodiments, first-Nth industrial process outlet 950A-950N may be different stages of the same process for producing, for example, steel, cement, glass, chemicals, aluminum, and/or ceramics. Additionally, or alternatively, two or more first-Nth industrial process outlets 950A-950N may be for different manufacturing/industrial processes for producing different materials. In either case, the industrial processes may be performed within the same building and/or with the same equipment and/or may be performed with different equipment in locations remote from one another.

The components of system 900 may be physically, communicatively, and/or electrically coupled to one another and these couplings and/or communication via the couplings are represented by lines in FIG. 9A. Components of system 900 may be communicatively coupled via, for example, wired and/or wireless communication connections and/or networks (e.g., the Internet and/or a private network) via any acceptable means. Additionally, or alternatively, components of system 900 may be electrically coupled together via, for example, wires, leads, manifolds, couplings, and/or other devices. Additionally, or alternatively, components of system 900 may be physically coupled together via, for example, ducts, pipes, conduits, exchangers, fans, and/or valves.

One or more operations, such as duty cycles, operational parameters, recharging and/or monitoring of system 900 and/or a component thereof may be performed by processor and/or controller 920 responsively to, for example, a set of instructions stored thereon and/or received via user interface 925. User interface 925 may be any user interface device including, but not limited to, a display device, a user input device (e.g., touch screen, microphone, trackpad, button, keypad, etc.), and/or a user output device (e.g., display, speaker, etc.).

Housing 905 may be configured to house array 910, which may include tens, hundreds, or thousands of thermal storage units 100 that may be stacked on top of one another (e.g., stacks 700A, 700B, 700C, and/or 700D) and arranged in rows. Housing 905 may further be configured to physically couple array 910 to heat transfer fluid circulation system 935 (and optionally to heat transfer fluid source(s) 930) and one or more of the plurality of industrial process outlets 950A-950N. Housing 905 may further be configured to electrically couple (in series and/or parallel) array 910, rows of thermal storage units 100 included in array 910, stacks of thermal storage units 100 included in a row of array 910, and/or individual thermal storage units 100 to electricity source(s) 915.

In addition, housing 905 may be configured to protect array 910 from a surrounding and/or ambient environment and/or insulate array 910 so that heat from array 910 does not escape into the surroundings and/or ambient environment. To that end, housing 905 may include a casing layer 906 and an insulation layer 908 (see FIG. 9B). Casing layer 906 may be configured to protect array 910 and/or components of system 900 from the surrounding and/or ambient environment and may comprise and/or be made from any acceptable material including, but not limited to, metal (e.g., steel), polymers, and/or cement. Insulation layer 908 may be configured to retain heat within housing 905 and/or the thermal storage units of array 910 for hours, days, and/or weeks at a time. Insulation layer 908 may comprise, for example, a ceramic material, such as, but not limited to, alumina, alumina-silicate, magnesia, or zirconia. In some embodiments, insulation layer 908 may include two or more layers of insulation configured to, for example, provide varying insulation properties at varying price points. For example, insulation layer 908 may include a first insulation layer proximate to array 910 configured and/or selected to keep heat within array 910 and a second insulation layer proximate to casing layer 905 configured to insulate array 910 from outside temperatures. In this embodiment, the first layer may comprise alumina, alumina-silicate, magnesia, or zirconia and the second layer of insulation may comprise a less expensive insulation material like fiberglass.

In some embodiments, heat transfer fluid source(s) 930 may simply be ambient air within an environment (e.g., a building) or ambient air outside a building or structure housing heat transfer fluid circulation system 935 and/or housing 905. In these embodiments, heat transfer fluid circulation source 935 may include one or more components open to the ambient air so that it may be sucked into heat transfer fluid circulation source 935 and distributed across and/or through array 910. Additionally, or alternatively, heat transfer fluid source(s) 930 may include a source (e.g., a canister or tank) of gas (e.g., argon gas) that, on some occasions, may be pressurized. Exemplary gasses include, but are not limited to, air, argon gas, recycled industrial gasses, flue gasses, carbon dioxide, and/or combustion gasses including, for example, hydrogen, carbon monoxide, and/or CH4. Additionally, or alternatively, in some embodiments, heat transfer fluid source(s) 930 may include recycled heat transfer fluid from one or more industrial processes like first-Nth industrial processes 950A-950N, heating or smelting facilities, and/or flue gasses. In these embodiments, heat transfer fluid source 930 and/or heat transfer fluid circulation system 935 may include duct work and/or an exhaust system in communication with an industrial process so that previously used heat transfer fluid 940 may be recycled from the industrial process once it has cooled somewhat (e.g., by 10-40%) so that its temperature is already elevated above, for example, ambient temperatures.

Often times, the heat transfer fluid of heat transfer fluid source(s) 930 is of ambient temperature but, this need not always be the case. In some examples, the heat transfer fluid may be pre-heated and/or heat transfer fluid may be recycled once it has delivered a portion of its heat to an industrial process.

Heat transfer fluid circulation system 935 may be any system configured to move, or transfer, heat transfer fluid from heat transfer fluid source(s) 930 into housing 905 and/or array 910 so that it flows over, and picks up heat from, array 910. In some embodiments, heat transfer fluid circulation system 935 may be configured as and/or include one or more fans, blowers, valves, ducts, and/or pipes configured to carry heat transfer fluid from heat transfer fluid source(s) 930 to housing 905 and/or a portion thereof (e.g., one or more rows of thermal storage units 100 of array 910).

Electricity source(s) 915 may be any source of electrical power including, but not limited to, traditional electrical power grids, locally placed renewable energy sources (e.g., photovoltaic arrays or wind turbines), and/or remotely placed renewable energy sources. In some embodiments, the timing and/or sourcing of electricity provided by electricity source(s) 915 to array 910 may be optimized to reduce costs and/or improve efficiency. For example, if power source 915 is a photovoltaic array, the electricity it provides may be delivered to array 910 during the day and/or during peak sunlight hours. The heat generated by the electricity from the photovoltaic array may then be stored in array 910 until needed (e.g., when heat transfer fluid circulation system 935 is activated). Additionally, or alternatively, when power source 915 is an electricity grid, it may provide electricity to array 910 during time periods when energy costs are lower (e.g., off-peak hours) as may occur during the evening and/or early morning. In some embodiments, system 900 (or components thereof) may act as a battery that converts electricity when available and/or inexpensive into heat stored within the thermal storage units 100 of array 910 for later use on demand and/or when otherwise needed when, for example, it may not be available (e.g., at night for photovoltaic sources) or may be more expensive to source (e.g., during peak daylight hours).

In the example of FIG. 9B, array 910 includes five stacks 700A, 700B, 700C, and/or 700D of first, second, third, and/or fourth block-shaped thermal storage units 100A1, 100A2, 100A3, and/or 100A4, first, second, third, and/or fourth cylindrically-shaped thermal storage units 100B1, 100B2, 100B3, and/or 100B4, first, second, third, and/or fourth hexagonally-shaped thermal storage units 100C1, 100C2, 100C3, and/or 100C4, and/or first, second, third, and/or fourth tube-shaped thermal storage unit 100E1, 100E2, 100E3, and/or 100E4, which may be collectively referred to herein as “thermal storage units 100” arranged in rows within housing 905 and on the inside of insulation layer 908. In the embodiment of FIG. 9B, each stack 700A, 700B, 700C, and/or 700D includes fifteen thermal storage units 100 directly, or indirectly, in electrical communication with electricity source(s) 915 via electricity communication plates 710, electrical leads 715, wiring 720, grounding plate 730, and grounding wiring 735. During use, electricity is delivered to each stack 700A, 700B, 700C, and/or 700D via wiring 720 extending between electricity source(s) 915 and electrical lead 715. The delivered electricity flows through thermal storage units 100 of the respective stack 700A, 700B, 700C, 700D, or 700E and eventually exits the stack via grounding plate 730 and/or grounding wiring 735. As electricity flows through each stack 700A, 700B, 700C, and/or 700D, thermal storage units 100 thereof become resistively heated to temperatures ranging between about 1,000 and 2,000° C.

When needed and/or desired, heat may be transferred from array 910 and/or a subset of thermal storage units 100 of array 910 to one or more of first-Nth industrial process outlet(s) 950A-950N according to, for example, instructions provided by processor and/or controller 920 via circulating and/or flowing a volume of heat transfer fluid 940 (see FIG. 9B) from heat transfer fluid source(s) 930 over, around, and/or through array 910. This circulation and flow of the volume of heat transfer fluid 940 may be performed by heat transfer fluid circulation system 935. As it is proximate to and/or flows around array 910, and/or thermal storage units 100, heat from thermal storage units 100 and/or array 910 may transfer to heat transfer fluid 940 via conduction, convection, and/or radiation, thereby forming heated heat transfer fluid 945 (see FIG. 9B) for communication to one or more industrial process outlets 950 via, for example, ducts or pipes 955 physically connecting array 910 to the one or more industrial process outlets 950.

In some embodiments, as thermal storage units 100 are cooled via, for example, conduction, convection, and/or radiation that may, or may not be, absorbed by heat transfer fluid, they may be reheated on a periodic, continuous (e.g., heated while heat transfer gas is flowing around them), and/or as-needed basis by, for example, adding more electricity to array 910 and/or resistively heating thermal storage units 100 as, for example, described herein.

In some embodiments, the thermal storage units 100 of each stack 700 within an array may be the same and, in other embodiments, they may be different. Additionally, or alternatively, a stack 700 may include thermal storage units 100 of the same kind but an array 910 may include stacks 700 of different kinds of thermal storage units. For example, an array 910 may include a first set of stacks that include a plurality of block-shaped thermal storage units 100A1 and a second set of stacks that include a plurality of block-shaped thermal storage units 100B1. In another example, an array 910 may include a first set of stacks that include a plurality of block-shaped thermal storage units 100B1 and a second set of stacks that include a plurality of hexagonally-shaped thermal storage units 100C1, wherein the coating layers for the block-shaped and hexagonally-shaped thermal storage units are the same. Alternatively, continuing with this example, the coating layers for the block-shaped and hexagonally-shaped thermal storage units may be different as may be desired when, for example, two different heat transfer fluids are used within a housing 905 for this array.

In some embodiments, system 900 may be used to provide heat for cement, steel, glass, chemicals, aluminum, and/or ceramics manufacturing industrial processes. For example, there are multiple points in the cement production process that require process heat like the heat generated by system 900 for the cement to be manufactured. Exemplary points in the cement manufacturing process that may utilize process heat like the heat generated by system 900 occur when cement components are dried by blowing hot air and flue gases over the material to remove moisture therefrom; when materials (e.g., limestone) are in a pre-calciner and hot gases are blown past the materials to begin one or more chemical reactions; when clinker is produced in a rotary cement kiln by heating the material in the kiln.

In another example, the process heat generated by system 900 may be used during multiple points in the steel production process including, but not limited to, iron pelletization (which traditionally requires blowing air and flue gases over the material to drive the drying and sintering processes to generate the iron pellets) and to drive hot air into the bottom of a blast furnace to drive the chemical reaction that generates the steel.

In some embodiments, system 900 may be configured to operate in an oxidizing environment, wherein heat transfer fluid 940 is and/or contains an oxidizing agent such as air, flue gasses, and/or CO2. Oxidizing environments may be used when the industrial processes are, for example, cement manufacturing and/or applications that use blast furnaces including, but not limited to the production of iron, pig iron, lead and/or copper. In these embodiments, the thermal storage units and/or systems disclosed herein may be configured and/or coated to resist oxidation and/or degradation so that, for example, electrical properties of the thermal storage units and/or substrates of the thermal storage units may be maintained through multiple (e.g., hundreds, thousands, hundreds of thousands, etc.) duty/use cycles. One way to configure thermal storage units to resist oxidation is to use an outer, or protective, coating layer that comprises a material that is air-stable and/or stable in an oxidizing environment, such as an oxide. Additionally, or alternatively, a coating layer underlying the protective coating layer may be configured to prevent the diffusion of oxygen through the coating layers and/or prevent diffusion of oxygen to an underlying substrate. Additionally, or alternatively, a coating layer underlying the protective coating layer may be configured to minimize solid-phase reactions and/or thermal expansion mismatch between the substrate and the coating layers. There might be a bond coating layer that ensures strong mechanical adhesion between the coatings and the substrate.

Additionally, or alternatively, in some embodiments, system 900 may be configured to operate in a mechanically and/or chemically corrosive environment, wherein heat transfer fluid 940 is and/or contains, for example, flue gasses and/or oxidizing gasses and/or for embodiments where heated heat transfer fluid 945 may be recycled. In these embodiments, the thermal storage units and/or systems disclosed herein may be configured and/or coated to resist corrosion and/or degradation so that, for example, electrical properties of the thermal storage units and/or substrates of the thermal storage units may be maintained through multiple (e.g., hundreds, thousands, hundreds of thousands, etc.) duty/use cycles. One way to configure thermal storage units to resist corrosion is to use an outer, or protective, coating layer that comprises a material that is stable in a corrosive environment, such as an oxide. Additionally, or alternatively, a coating layer underlying the protective coating layer may be configured to prevent the diffusion of oxygen and/or corrosive chemicals through the coating layers and/or prevent diffusion of oxygen and/or corrosive chemicals to an underlying substrate. Additionally, or alternatively, a coating layer underlying the protective coating layer may be configured to minimize solid-phase reactions and/or thermal expansion mismatch between the substrate and the coating layers. There might be a bond coating layer that ensures strong mechanical adhesion between the coatings and the substrate.

In some embodiments, system 900 may be configured to operate in a reducing environment, wherein heat transfer fluid 940 is and/or contains a reducing agent such as CH4, H2, CO, and/or fuel (e.g., natural gas, syngas, and/or combustion gasses) as may be useful for preheating fuel and/or industrial processes (natural gas or hydrogen based) that produce direct-reduced iron. In these environments, the thermal storage units may be uncoated (e.g., just the substrate as with thermal storage unit(s) 100A1, 100B1, 100C1, and/or 100E1) and/or may include one or more coating layers configured to be reduction resistant.

Additionally, or alternatively, in some embodiments, system 900 may be configured to operate in an inert environment, wherein heat transfer fluid 940 is and/or contains one or more inert ingredients and/or gasses such as argon and/or nitrogen. These systems and/or the thermal storage units therein may be configured to operate within and/or as a closed loop system, such as, but not limited to, a steam cracker system and/or a steam methane reformer as may be used in the chemical production industry and/or some ceramic manufacturing processes. In these embodiments, the thermal storage units may be uncoated (e.g., just the substrate as with thermal storage unit(s) 100A1, 100B1, 100C1, and/or 100E1) and/or may include one or more coating layers configured to be extend a lifetime of the thermal storage unit, increase it stability, and/or provide a higher vaporization resistance at high temperatures.

Additionally, or alternatively, in some embodiments, system 900 may be configured to operate in a carburizing environment, wherein heat transfer fluid 940 is and/or contains one or more gasses that can form solid carbon, such as CH4 and/or CO. These systems and/or the thermal storage units therein may be configured to provide heat to industrial processing equipment that makes direct reduced iron and/or preheats fuel. In these embodiments, the thermal storage units may be uncoated (e.g., just the substrate as with thermal storage unit(s) 100A1, 100B1, 100C1, and/or 100E1) and/or may include one or more coating layers configured to extend the lifetime of the thermal storage unit, increase its stability, and/or provide a higher vaporization resistance at high temperatures within a carburizing atmosphere. Additionally, or alternatively, the coatings may be configured to be stable in high-temperature steam and/or oxygen-containing gas environments that may be used to clean carbon deposits from the thermal storage units and/or equipment of system 900.

Additionally, or alternatively, in some embodiments, system 900 may be configured to operate in a steam (e.g., vaporized H2) environment, wherein heat transfer fluid 940 is and/or contains steam. In these embodiments, the thermal storage units and/or systems disclosed herein may be configured and/or coated to resist corrosion and/or degradation so that, for example, electrical properties of the thermal storage units and/or substrates of the thermal storage units may be maintained through multiple (e.g., hundreds, thousands, hundreds of thousands, etc.) duty/use cycles. One way to configure thermal storage units to resist corrosion is to use an outer, or protective, coating layer that comprises a material that is stable in a steam environment, such as an oxide. Additionally, or alternatively, a coating layer underlying the protective coating layer may be configured to prevent the diffusion of oxygen and/or corrosive chemicals through the coating layers and/or prevent diffusion of oxygen and/or corrosive chemicals to an underlying substrate. Additionally, or alternatively, a coating layer underlying the protective coating layer may be configured to minimize solid-phase reactions and/or thermal expansion mismatch between the substrate and the coating layers. There might be a bonding coating layer that ensures strong mechanical adhesion between the coatings and the substrate.

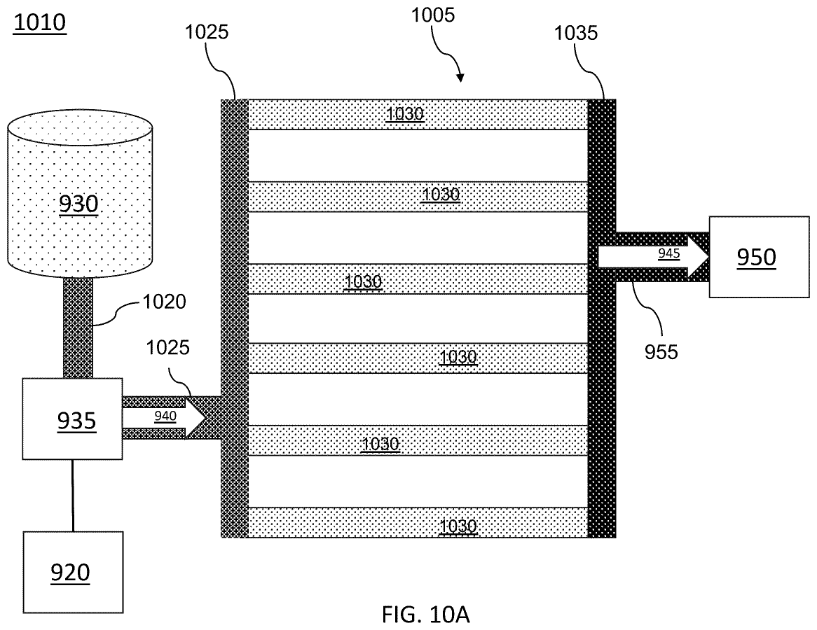

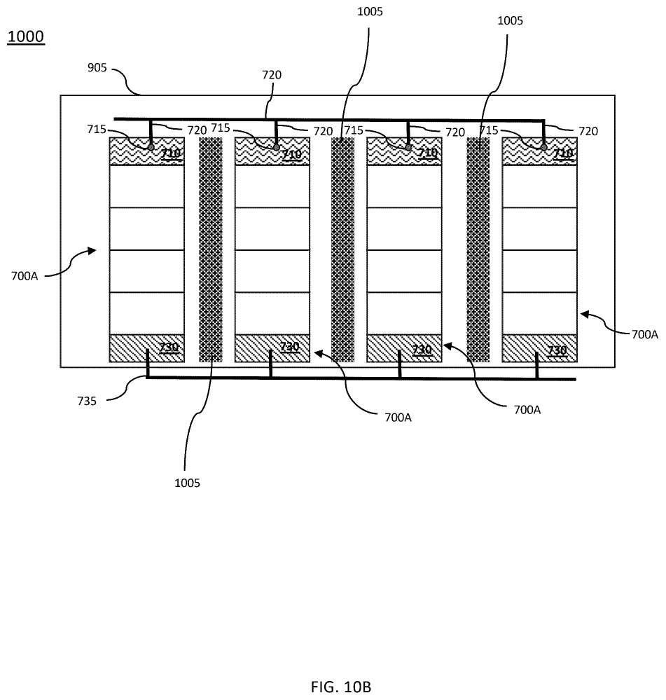

FIG. 10A provides a schematic diagram of a heat exchanger system 1010 that may be used with one or more of the thermal storage systems (e.g., system 900) and/or thermal storage units described herein. Heat exchanger system includes heat transfer fluid source 930, heat transfer fluid circulation system 935, an array 1005 of heat exchanging tubes 1030, an industrial process outlet 950, processor and/or controller 920, and plumbing connecting the components of system. Operation of system 1010 may be controlled by processor and/or controller 920. The tubes and/or plumbing of system 1010 may comprise, for example, stainless steel or ceramic (e.g., densified alumina or mullite) plumbing and/or plumbing components.

Heat transfer source 930 may be embodied as a water or heat transfer fluid tank and heat transfer fluid circulation system 935 may be embodied as a pump configured to draw heat transfer fluid 940 from heat transfer source 930 via a first plumbing connection 1020 and push it into a manifold 1025 via a second plumbing connection 1025. Heat transfer fluid 940 may then be pushed from manifold 1025 through one or more heat exchanging tubes 1030 which may be positioned to one or more thermal storage units like the thermal storage units disclosed herein. As heat transfer fluid 940 travels through heat exchanging tubes 1030, it may absorb heat from the thermal storage units, which may convert the heat transfer fluid to heated heat transfer fluid 945, which may convert heat transfer fluid 940 from a liquid to a gas (e.g., steam or super-heated steam ranging from about 100-600° C.) that may, or may not be, pressurized. As heated heat transfer fluid 945 travels through heat exchanging tubes 1030 it may enter a heated heat transfer fluid manifold 1035, which may be connected to industrial process equipment 950 via tubes 955. In system 1010, industrial process equipment 950 may be embodied as one or more steam turbines configured to, for example, convert steam into electricity.

FIG. 10B provides a schematic diagram of a thermal storage system 1000 that includes heat exchanger system 1010. Thermal storage system 1000 may be set up in a manner similar to that shown in FIG. 9B with the addition of one or more heat exchanger system(s) 1010 or components thereof. For example, in the embodiment shown in FIG. 10B, thermal storage system 1000 includes one or more array(s) 1005 positioned between each stack of thermal storage units (in this example stack 700A) so that heat transfer fluid passing through heat exchanging tubes 1030 may be heated via heat emanating from the stack on one or both sides thereof. The heated heat transfer fluid may then travel through pipes 955 to industrial process equipment 950 as shown in FIG. 10A.

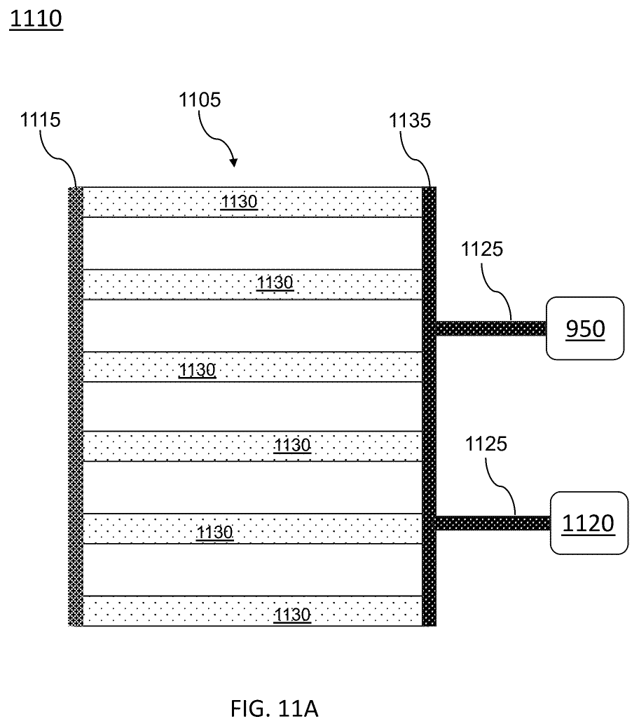

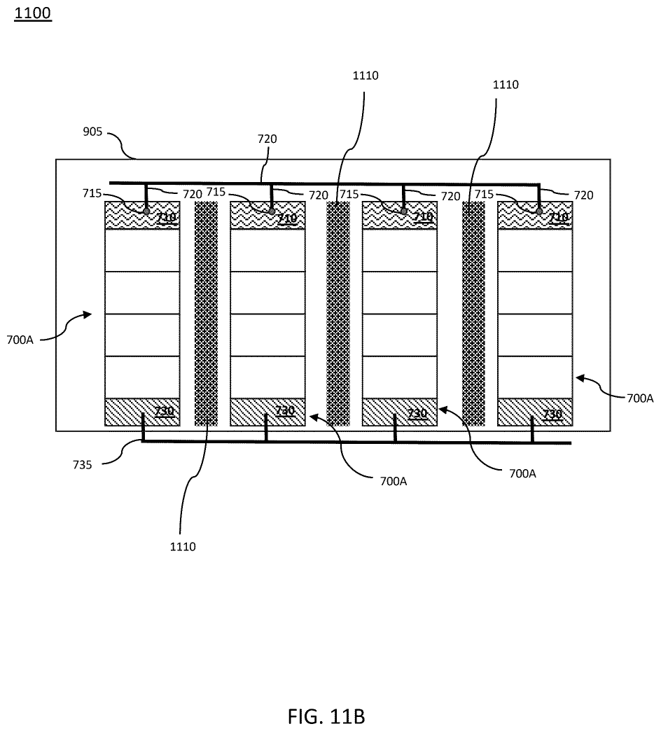

FIG. 11A provides a schematic diagram of a thermophotovoltaic system 1110 that may be used with one or more of the thermal storage systems and/or thermal storage units described herein. Thermophotovoltaic system 1110 includes an array 1105 of thermophotovoltaic components 1130 configured to convert heat from the thermal storage units and/or thermal storage systems disclosed herein into electricity. Thermophotovoltaic components 1130 may be held in place by scaffolding 1115, which may be embodied as, for example, shelving. Often times, thermophotovoltaic components 1130 are optimized to absorb radiation at wavelengths emitted by thermal storage systems and/or thermal storage units described herein. In some embodiments, thermophotovoltaic components 1130 may be water cooled. Electricity produced by thermophotovoltaic components 1130 and/or array 1105 may be communicated to an electrical manifold, or bus, 1135 that communicates the electricity to industrial process equipment 950 and/or other electrical components 1120, which may be, for example, a battery, power tools, lights, and/or other equipment that may use electrical power.

In some embodiments, scaffolding 1115 may be configured to move so that thermophotovoltaic system 1110 and/or thermophotovoltaic components 1130 may be moved closer to and/or further away from thermal storage units as needed. For example, scaffolding 1115 may be moved proximate to one or more stacks of thermal storage units when conversion of heat to electricity is desired and/or necessary and moved away from one or more stacks of thermal storage units when, for example, thermophotovoltaic system 1110 and/or thermophotovoltaic components 1130 is in danger of overheating and/or not needed.

FIG. 11B provides a schematic diagram of a thermal storage system 1100 that includes thermophotovoltaic system 1110. Thermal storage system 1100 may be set up in a manner similar to that shown in FIG. 9B and/or 10B with the addition of one or more thermophotovoltaic system(s) 1110 or components thereof. For example, in the embodiment shown in FIG. 11B, thermal storage system 1100 includes one or more array(s) 1105 positioned between each stack of thermal storage units (in this example stack 700A) so heat emitted by the thermal storage units thereof may be converted into electricity by thermophotovoltaic components 1130. The generated electricity may then be communicated to industrial process equipment 950 and/or other electrical components 1120 as shown in, for example, FIG. 11A.

As used herein, the terms “about” or “approximate” and the like are synonymous and are used to indicate that the value modified by the term has an understood range associated with it, where the range can be ±20%, ±15%, ±10%, ±5%, or ±1%. The terms “substantially” and the like are used to indicate that a value is close to a targeted value, where close can mean, for example, the value is within 80% of the targeted value, within 85% of the targeted value, within 90% of the targeted value, within 95% of the targeted value, or within 99% of the targeted value. In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

We claim:

1. A thermal storage unit for storing high-temperature heat comprising:
a substrate comprising silicon carbide.

2. The thermal storage unit of claim 1, wherein the thermal storage unit comprises a composite material comprising silicon carbide and at least one of an oxide, a carbide, a boride, a nitride, a phosphate, a silicate, a silicide, and a zirconate.

3. The thermal storage unit of claim 1, wherein the thermal storage unit comprises a silicon carbide composite material selected from the group comprising SiC—C, SiC—B4C, SiC—Cr2O3, SiC—Al2O3, SiC—CeC2, SiC—CaO, and SiC—MgO.

4. The thermal storage unit of claim 1, wherein the thermal storage unit is configured to store heat ranging from about 1000° C. to about 2000° C.

5. The thermal storage unit of claim 1, wherein the thermal storage unit is to be resistively heated to a temperature ranging from about 1000° C. to about 2000° C.

6. The thermal storage unit of claim 1, wherein the thermal storage unit is configured to be arranged in a stack of thermal storage units, each of the thermal storage units of the stack being in electrical communication with one another.

7. The thermal storage unit of claim 1, further comprising a coating layer.

8. The thermal storage unit of claim 7, wherein the coating layer is configured to protect the substrate from at least one of a heat transfer fluid and a corrosive environment.

9. The thermal storage unit of claim 7, wherein the coating layer is a multi-purpose coating layer.

10. The thermal storage unit of claim 1, further comprising a plurality of coating layers.

11. The thermal storage unit of claim 10, wherein at least one layer of the plurality of coating layers is a bonding coating layer configured to assist with adherence of another coating layer of the plurality of coating layers to the thermal storage unit.

12. The thermal storage unit of claim 10, wherein at least one layer of the plurality of coating layers is a protective coating layer configured to protect the thermal storage unit.

13. The thermal storage unit of claim 12, wherein the surface coating layer is further configured to prevent and/or control gas phase reactions between the thermal storage unit and an atmosphere in which the thermal storage unit is resident.

14. The thermal storage unit of claim 10, wherein at least one layer of the plurality of coating layers is an intermediate coating layer configured to minimize thermal and/or chemical mismatch between the substrate and one or more of the plurality of layers of the thermal storage unit.

15. The thermal storage unit of claim 14, wherein the intermediate coating layer is a first intermediate coating layer, the thermal storage unit further comprising:
a second intermediate coating layer configured to minimize thermal and/or chemical mismatch between the substrate and one or more of the plurality of layers of the thermal storage unit.

16. The thermal storage unit of claim 1, further comprising:
a first coating layer;
a second coating layer; and
a third coating layer.

17. The thermal storage unit of claim 16, wherein the first coating layer is in contact with a surface of the thermal storage unit and is configured as a base coating layer, the second layer is positioned between the first and third coating layers and is configured to provide thermal expansion stability and/or chemical stability between materials comprising the substrate, first, second, and/or third coating layers, and the third layer is configured to protect the thermal storage unit.

18. A system comprising:
a stack comprising:
a plurality of thermal storage units comprising a substrate comprising silicon carbide arranged to be in electrical communication with one another;
a coupling to an electricity source configured to supply electricity to the plurality of thermal storage units; and
a coupling to an electrical ground; and
a housing configured to house the stack.

19. The system of claim 18, further comprising:
a heat transfer fluid circulation system configured to circulate a volume heat transfer fluid within and/or through the housing so that heat is transferred from the stack to the volume of heat transfer fluid, thereby generating a volume of heated heat transfer fluid, wherein the heat transfer fluid circulation system is further configured to deliver the heated heat transfer fluid to an industrial process outlet; and
the industrial process outlet being in communication with the housing and configured to communicate a portion of the volume of heated heat transfer fluid from the housing to industrial process equipment proximate to the industrial process outlet.

20. The system of claim 19, wherein the industrial processing equipment is at least one of a furnace, a blast furnace, cement processing equipment, metal processing equipment, nickel processing equipment, copper processing equipment, rare earth metal processing equipment, aluminum processing equipment, ceramic processing equipment, steel processing equipment, glass processing equipment, and chemical processing equipment.

21. The system of claim 19, wherein the heat transfer fluid is at least one of flue gases, CO2, nitrogen, CO, CH4, H2O, steam, hydrogen, argon, air, and a combination thereof.

22. The system of claim 19, wherein the heat transfer circulation system is further configured to remove heat transfer fluid from the industrial process equipment and recirculate it through the housing so that it may be reheated and redelivered to the industrial process equipment.
